(19) United States
(12) Patent Application Publication
(10) Pub. No.: US 2014/0133419 A1
(43) Pub. Date: May 15, 2014

(54) METHOD FOR COORDINATING INTER-CELL INTERFERENCE IN RADIO NETWORK, BASE STATION AND RADIO NETWORK

(71) Applicants: Satoshi Nagata, Tokyo (JP); Yu Jiang, Beijing (CN); Jing Wang, Beijing (CN); Xiaoming She, Beijing (CN); Lan Chen, Beijing (CN)

(72) Inventors: Satoshi Nagata, Tokyo (JP); Yu Jiang, Beijing (CN); Jing Wang, Beijing (CN); Xiaoming She, Beijing (CN); Lan Chen, Beijing (CN)

(73) Assignee: NTT DOCOMO, INC., Tokyo (JP)

(21) Appl. No.: 14/117,686

(22) PCT Filed: May 10, 2012
(86) PCT No.: PCT/JP2012/062006

§ 371 Date: Dec. 6, 2013

(30) Foreign Application Priority Data
May 17, 2011 (CN) 201110137290.0

(51) Int. Cl. H04L 5/00

(52) U.S. Cl. CPC H04L 5/0073
USPC 370/329

(57) ABSTRACT

Provided are a method for coordinating inter-cell interference in a radio network, a transmission point and the radio network. The method includes: a step A of a normal base station performing scheduling based on feedback information of users of the normal base station and obtain a user scheduling result of the normal base station including a parameter about actual transmission characteristics of the normal base station; a step B of the normal base station obtaining a performance estimating parameter including a parameter about actual transmission characteristics of each of the one or plurality of low-power base stations for both cases of normal base station without transmission and normal base station with transmission; a step C of the normal base station using the performance estimating parameter and the user scheduling result of the normal base station as a basis to determine weighting throughputs of all transmission points for the case of normal base station without transmission and weighting throughputs of all the transmission points for the case of normal base station with transmission; and a step D of the normal base station comparing the weighting throughputs of all the transmission points, obtaining a transmission determination result and performing data transmission based on the transmission determination result.

### TECHNICAL FIELD

The present invention relates to a radio communication field, and particularly, to a method for coordinating inter-cell interference in a radio network, a base station and the radio network.

### BACKGROUND ART

A heterogeneous network (HetNet) has been considered a development of the current radio network coverage technology. In the heterogeneous network, there are arranged, in addition to normal base stations (e.g., macro base stations (macro eNB)) used in 2G or 3G network, many low-power base stations (e.g., pico base stations (pico eNB), femto base stations (femto eNB), base-station remote radio heads (RRHs), relay stations, micro base stations (micro eNB) etc.). These low-power base stations contribute to improvement in cell's total throughput and cell coverage. However, a user connected to such a low-power base station suffers from strong interference from a macro base station whose coverage overlaps the coverage of the low-power base station. Accordingly, in the heterogeneous network, there is a need to use enhanced inter-cell interference coordination (eICIC).

### SUMMARY OF INVENTION

### Technical Problem

In the current 3GPP standardization, a study about eICIC is focused on reduction in interference of a normal base station with a user of a low-power base station by opening and closing the normal base station in time domain. For example, in 3GPP Rel. 10, semi-static eICIC has been studied intensively. In this technique, a macro base station is controlled as to open and closed states based on a preset transmission pattern (muting pattern). However, if the muting pattern is fixed in each transmission time interval (TTI), it is not optimal for cell total throughput. Accordingly, there is proposed a dynamic eICIC. However, at present, this dynamic eICIC technique does not consider mutual difference between different transmission points or different base stations. Accordingly, determination by a macro base station is sometimes unfair, which may cause relative deterioration of performance of the dynamic eICIC finally.

The present invention provides a method for coordinating inter-cell interference in a radio network, a base station and the radio network so as to ensure better performance of inter-cell interference coordination.

### Solution to Problem

The present invention provides a method for coordinating inter-cell interference in a radio network including a normal base station and one or a plurality of low-power base stations within coverage of the normal base station as transmission points, the method comprising: a step A of the normal base station performing scheduling based on feedback information of a user of the normal base station and obtaining a user scheduling result of the normal base station including a parameter about an actual transmission characteristic of the normal base station; a step B of the normal base station obtaining a performance estimating parameter including a parameter about an actual transmission characteristic of each of the one or plurality of low-power base stations for both cases of normal base station without transmission and normal base station with transmission; a step C of the normal base station using the performance estimating parameter and the user scheduling result of the normal base station as a basis to determine weighting throughputs of all the transmission points for the case of normal base station without transmission and weighting throughputs of all the transmission points for the case of normal base station with transmission; and a step D of the normal base station comparing the weighting throughputs of all the transmission points, obtaining a transmission determination result and performing data transmission based on the transmission determination result.

The step B includes the normal base station receiving feedback information of a user of the one or plurality of low-power base stations, performing user scheduling of each of the low-power base stations for the case of normal base station without transmission to obtain a first user set A_{Pj}, performing user scheduling of each of the low-power base stations for the case of normal base station with transmission to obtain a second user set B_{Pj}, performing performance estimation on the first user set A_{Pj} and second user set B_{Pj}, and obtaining an appropriate performance estimating parameter.

The method further comprises the normal base station sending the transmission determination result as feedback to the one or plurality of low-power base stations, and each of the low-power base stations performing user scheduling of own station based on the transmission determination result thereby to perform data transmission.

The method further comprises: prior to the step B,

each of the low-power base stations performing pre-scheduling based on feedback information of a user of own station and obtaining a first user set A_{Pj} for the case of normal base station without transmission and a second user set B_{Pj} for the case of normal base station with transmission; and each of the low-power base stations performing performance estimation on each of the first user set A_{Pj} and the second user set B_{Pj} and feeding an obtained performance estimating parameter back to the normal base station.

The method further comprises: the normal base station feeding the transmission determination result to the one or plurality of low-power base stations; and each of the one or plurality of low-power base stations using the transmission determination result as a basis to determine an appropriate user set out of the first user set A_{Pj} and the second user set B_{Pj} and performing data transmission.

In the step C, the normal base station determines the weighting throughputs of all the transmission points for the case of normal base station without transmission by using an equation:

$${\sum }_{j = 1}^{{N}_{PeNB}} {\sum }_{i ∈ {A}_{{p}_{j}}}^{ } \frac{{R}_{{p}_{j} , i}^{′} ( t )}{{\overline{R}}_{{p}_{j} , i} ( t ) \cdot {N}_{{p}_{j}}}$$

$$or$$

$${\sum }_{j = 1}^{{N}_{PeNB}} {\sum }_{i ∈ {A}_{{p}_{j}}}^{ } \frac{{R}_{{p}_{j} , i}^{′} ( t )}{{\overline{R}}_{{p}_{j} , i} ( t ) \cdot f ( {N}_{{p}_{j}} )}$$

and determines the weighting throughputs of all the transmission points for the case of normal base station with transmission by using an equation:

$${\sum }_{i ∈ {M}_{m}}^{ } \frac{{R}_{m , i} ( t )}{{\overline{R}}_{m , i} ( t ) \cdot {N}_{m}} + {\sum }_{ j = 1}^{{N}_{PeNB}} {\sum }_{i ∈ {B}_{{p}_{j}}}^{ } \frac{{R}_{{p}_{j} , i} ( t )}{{\overline{R}}_{{p}_{j} , i} ( t ) \cdot {N}_{{p}_{j}}}$$

$$or$$

$${\sum }_{i ∈ {M}_{m}}^{ } \frac{{R}_{m , i} ( t )}{{\overline{R}}_{m , i} ( t ) \cdot {N}_{m}} + {\sum }_{ j = 1}^{{N}_{PeNB}} {\sum }_{i ∈ {B}_{{p}_{j}}}^{ } \frac{{R}_{{p}_{j} , i} ( t )}{{\overline{R}}_{{p}_{j} , i} ( t ) \cdot f ( {N}_{{p}_{j}} )} ,$$

where t denotes a current time, i denotes a user number of the normal base station or each of the one or plurality of low-power base stations, j denotes a low-power base station number, Pⱼ denotes a j-th low-power base station, N_{PeNB} denotes a number of low-power base stations, Nₘ denotes a number of users of the normal base station, f(Nₘ) denotes a function of Nₘ, N_{Pj} denotes a number of users of the j-th low-power base station, f(N_{Pj}) is a function of N_{Pj}, Rₚ_{ⱼ}_{,i}′ denotes a throughput of an i-th user in an appropriate user set of the j-th low-power base station for the case of normal base station without transmission, Rₚ_{ⱼ}_{,i} denotes a throughput of the i-th user in an appropriate user set of the j-th low-power base station for the case of normal base station with transmission, R̅ₚ_{ⱼ}_{,i} denotes an average throughput of the i-th user in an appropriate user set of the j-th low-power base station, R_{m,i} denotes a throughput of an i-th user in an appropriate user set of the normal base station, R̅_{m,i} denotes an average throughput of the i-th user in an appropriate user set of the normal base station, A_{Pj} denotes a first user set scheduled by the j-th low-power base station for the case of normal base station without transmission, B_{Pj} denotes a second user set scheduled by the j-th low-power base station for the case of normal base station with transmission, Mₘ denotes a normal base station user set scheduled by the normal base station.

In the step C, the normal base station determines the weighting throughputs of all the transmission points for the case of normal base station without transmission by using an equation:

$${\sum }_{j = 1}^{{N}_{PeNB}} {\sum }_{i ∈ {A}_{{p}_{j}}} \frac{{R}_{{p}_{j} , i}^{′} ( t )}{{\overline{C}}_{{p}_{j}} ( t )} or {\sum }_{j = 1}^{{N}_{PeNB}} {\sum }_{i ∈ {A}_{{p}_{j}}} \frac{{R}_{{p}_{j} , i}^{′} ( t )}{f ( {\overline{C}}_{{p}_{j}} ( t ) )}$$

and determines the weighting throughputs of all the transmission points for the case of normal base station with transmission by using an equation:

$${\sum }_{i ∈ {M}_{m}} \frac{{R}_{m , i} ( t )}{{\overline{C}}_{m} ( t )} + {\sum }_{j = 1}^{{N}_{PeNB}} {\sum }_{i ∈ {B}_{{p}_{j}}} \frac{{R}_{{p}_{j} , i} ( t )}{{\overline{C}}_{{p}_{j}} ( t )} or$$

$${\sum }_{i ∈ {M}_{m}} \frac{{R}_{m , i} ( t )}{f ( {\overline{C}}_{m} ( t ) )} + {\sum }_{j = 1}^{{N}_{PeNB}} {\sum }_{i ∈ {B}_{{p}_{j}}} \frac{{R}_{{p}_{j} , i} ( t )}{f ( {\overline{C}}_{{p}_{j}} ( t ) )}$$

where t denotes a current time, i denotes a user number of the normal base station or each of the one or plurality of low-power base stations, j denotes a low-power base station number, Pⱼ denotes a j-th low-power base station, N_{PeNB} denotes a number of low-power base stations, Rₚ_{ⱼ}_{,i}′ denotes a throughput of an i-th user in an appropriate user set of the j-th low-power base station for the case of normal base station without transmission, Rₚ_{ⱼ}_{,i} denotes a throughput of the i-th user in an appropriate user set of the j-th low-power base station for the case of normal base station with transmission, R_{m,i} denotes a throughput of an i-th user in an appropriate user set of the normal base station, C̅ₚ_{ⱼ} denotes an average throughput of the j-th low-power base station, f( C̅ₚ_{ⱼ}(t)) is a function of C̅ₚ_{ⱼ}, C̅ₘ
denotes an average throughput of the normal base station, f( C̅ₘ(t)) is a function of C̅ₘ, A_{Pj} denotes a first user set scheduled by the j-th low-power base station for the case of normal base station without transmission, B_{Pj} denotes a second user set scheduled by the j-th low-power base station for the case of normal base station with transmission, Mₘ denotes a normal base station user set scheduled by the normal base station.

The method further comprises the normal base station storing frame number information of own station.

In the step C, the normal base station determines the weighting throughputs of all the transmission points for the case of normal base station without transmission by using an equation:

$$( {\sum }_{j = 1}^{{N}_{PeNB}} {\sum }_{i ∈ {A}_{{p}_{j}}} {R}_{{p}_{j} , i}^{′} ( t ) ) \cdot ( T - {T}_{m} ) or ( {\sum }_{j = 1}^{{N}_{PeNB}} {\sum }_{i ∈ {A}_{{p}_{j}}} {R}_{{p}_{j} , i}^{′} ( t ) ) \cdot {f}_{1} ( T , {T}_{m} , {T}_{n} )$$

and determines the weighting throughputs of all the transmission points for the case of normal base station with transmission by using an equation:

$$( {\sum }_{i ∈ {M}_{m}} {R}_{m , i} ( t ) + {\sum }_{j = 1}^{{N}_{PeNB}} {\sum }_{i ∈ {B}_{{P}_{j}}} {R}_{{p}_{j} , i} ( t ) ) \cdot ( T - {T}_{n} ) or \\ ( {\sum }_{i ∈ {M}_{m}} {R}_{m , i} ( t ) + {\sum }_{j = 1}^{{N}_{PeNB}} {\sum }_{i ∈ {B}_{{P}_{j}}} {R}_{{p}_{j} , i} ( t ) ) \cdot {f}_{2} ( T , {T}_{m} , {T}_{n} )$$

where t denotes a current time, i denotes a user number of the normal base station or each of the one or plurality of low-power base stations, j denotes a low-power base station number, Pⱼ denotes a j-th low-power base station, N_{PeNB} denotes a number of low-power base stations, Rₚ_{ⱼ}_{,i}′ denotes a throughput of an i-th user in an appropriate user set of the j-th low-power base station for the case of normal base station without transmission, Rₚ_{ⱼ}_{,i} denotes a throughput of the i-th user in an appropriate user set of the j-th low-power base station for the case of normal base station with transmission, R_{m,i} denotes a throughput of an i-th user in an appropriate user set of the normal base station, A_{Pj} denotes a first user set scheduled by the j-th low-power base station for the case of normal base station without transmission, B_{Pj} denotes a second user set scheduled by the j-th low-power base station for the case of normal base station with transmission, T denotes a total number of frames, Tₘ denotes a number of frames without transmission of the normal base station, Tₙ denotes a number of frames with transmission of the normal base station, f₁(T, Tₘ, Tₙ) and f₂(T, Tₘ, Tₙ) both denote functions of T, Tₘ, Tₙ.

In the step C, the normal base station determines the weighting throughputs of all the transmission points for the case of normal base station without transmission by using an equation:

$$( {\sum }_{j = 1}^{{N}_{PeNB}} {\sum }_{i ∈ {A}_{{p}_{j}}} \frac{{R}_{{p}_{j} , i}^{′} ( t )}{{\overline{R}}_{{p}_{j} , i} ( t )} ) \cdot ( T - {T}_{m} ) or ( {\sum }_{j = 1}^{{N}_{PeNB}} {\sum }_{i ∈ {A}_{{p}_{j}}} \frac{{R}_{{p}_{j} , i}^{′} ( t )}{{\overline{R}}_{{p}_{j} , i} ( t )} ) \cdot {f}_{1} ( T , {T}_{m} , {T}_{n} )$$

and determines the weighting throughputs of all the transmission points for the case of normal base station with transmission by using an equation:

$$( {\sum }_{i ∈ {M}_{m}} \frac{{R}_{m , i} ( t )}{{\overline{R}}_{m , i} ( t )} + {\sum }_{j = 1}^{{N}_{PeNB}} {\sum }_{i ∈ {B}_{{P}_{j}}} \frac{{R}_{{p}_{j} , i} ( t )}{{\overline{R}}_{{p}_{j} , i} ( t )} ) \cdot ( T - {T}_{n} ) or ( {\sum }_{i ∈ {M}_{m}} \frac{{R}_{m , i} ( t )}{{\overline{R}}_{m , i} ( t )} + {\sum }_{j = 1}^{{N}_{PeNB}} {\sum }_{i ∈ {B}_{{P}_{j}}} \frac{{R}_{{p}_{j} , i} ( t )}{{\overline{R}}_{{p}_{j} , i} ( t )} ) \cdot {f}_{2} ( T , {T}_{m} , {T}_{n} )$$

where t denotes a current time, i denotes a user number of the normal base station or each of the one or plurality of low-power base stations, j denotes a low-power base station number, Pⱼ denotes a j-th low-power base station, N_{PeNB} denotes a number of low-power base stations, Rₚ_{ⱼ}_{,i}′ denotes a throughput of an i-th user in an appropriate user set of the j-th low-power base station for the case of normal base station without transmission, Rₚ_{ⱼ}_{,i} denotes a throughput of the i-th user in an appropriate user set of the j-th low-power base station for the case of normal base station with transmission, R̅Rₚ_{ⱼ}_{,i} denotes an average throughput of the i-th user in an appropriate user set of the j-th low-power base station, R_{m,i} denotes a throughput of an i-th user in an appropriate user set of the normal base station, R̅_{m,i} denotes an average throughput of the i-th user in an appropriate user set of the normal base station, A_{Pj} denotes a first user set scheduled by the j-th low-power base station for the case of normal base station without transmission, B_{Pj} denotes a second user set scheduled by the j-th low-power base station for the case of normal base station with transmission, T denotes a total number of frames, Tₘ denotes a number of frames without transmission of the normal base station, Tₙ denotes a number of frames with transmission of the normal base station, f₁(T, Tₘ, Tₙ) and f₂(T, Tₘ, Tₙ) both denote functions of T, Tₘ, Tₙ.

In the step C, the normal base station determines the weighting throughputs of all the transmission points for the case of normal base station without transmission by using an equation:

$${\sum }_{j = 1}^{{N}_{PeNB}} {\sum }_{i ∈ {A}_{{P}_{j}}} \frac{{R}_{{p}_{j} , i}^{′} ( t )}{{W}_{{p}_{j} , i} ( t )} or {\sum }_{j = 1}^{{N}_{PeNB}} {\sum }_{i ∈ {A}_{{P}_{j}}} \frac{{R}_{{p}_{j} , i}^{′} ( t )}{f ( {W}_{{p}_{j} , i} ( t ) )}$$

and determines the weighting throughputs of all the transmission points for the case of normal base station with transmission by using an equation:

$${\sum }_{i ∈ {M}_{m}} \frac{{R}_{m , i} ( t )}{{W}_{m , i} ( t )} + {\sum }_{j = 1}^{{N}_{PeNB}} {\sum }_{i ∈ {B}_{{P}_{j}}} \frac{{R}_{{p}_{j} , i} ( t )}{{W}_{{p}_{j} , i} ( t )} or$$

$${\sum }_{i ∈ {M}_{m}} \frac{{R}_{m , i} ( t )}{f ( {W}_{m , i} ( t ) )} + {\sum }_{j = 1}^{{N}_{PeNB}} {\sum }_{i ∈ {B}_{{P}_{j}}} \frac{{R}_{{p}_{j} , i} ( t )}{f ( {W}_{{p}_{j} , i} ( t ) )}$$

where W_{Pj,i}(t) denotes a total amount of data to transmit to an i-th user in an appropriate user set of a j-th low-power base station, f(W_{Pj,i}(t)) denotes a function of W_{Pj,i}(t), W_{m,i}(t) denotes a total amount of data to transmit to an i-th user in an appropriate user set of the normal base station, and f(W_{m,i}(t)) denotes a function of W_{m,i}(t).

In the step C, the normal base station determines the weighting throughputs of all the transmission points for the case of normal base station without transmission by using an equation:

$${\sum }_{j = 1}^{{N}_{PeNB}} {\sum }_{i ∈ {A}_{{P}_{j}}} ( {R}_{{p}_{j} , i}^{′} ( t ) \cdot {S}_{{p}_{j} , i} ( t ) ) or {\sum }_{j = 1}^{{N}_{PeNB}} {\sum }_{i ∈ {A}_{{P}_{j}}} ( {R}_{{p}_{j} , i}^{′} ( t ) \cdot f ( {S}_{{p}_{j} , i} ( t ) ) )$$

and determines the weighting throughputs of all the transmission points for the case of normal base station with transmission by using an equation:

$${\sum }_{i ∈ {M}_{m}} ( {R}_{m , i} ( t ) \cdot {S}_{m , i} ( t ) ) + {\sum }_{j = 1}^{{N}_{PeNB}} {\sum }_{i ∈ {B}_{{P}_{j}}} ( {R}_{{p}_{j} , i} ( t ) \cdot {S}_{{p}_{j} , i} ( t ) ) or$$

$${\sum }_{i ∈ {M}_{m}} ( {R}_{m , i} ( t ) \cdot f ( {S}_{m , i} ( t ) ) ) + {\sum }_{j = 1}^{{N}_{PeNB}} {\sum }_{i ∈ {B}_{{P}_{j}}} ( {R}_{{p}_{j} , i} ( t ) \cdot f ( {S}_{{p}_{j} , i} ( t ) ) )$$

where S_{Pj,i}(t) denotes a total amount of data to transmit to an i-th user in an appropriate user set of a j-th low-power base station, f(S_{Pj,i}(t)) denotes a function of S_{Pj,i}(t), S_{m,i}(t) denotes a total amount of data to transmit to an i-th user in an appropriate user set of the normal base station, and f(S_{m,i}(t)) denotes a function of S_{m,i}(t).

The present invention further provides a base station in a radio network comprising: a user scheduling module configured to perform scheduling based on feedback information of users of a normal base station and obtain a user scheduling result of the normal base station including a parameter about actual transmission characteristics of the normal base station; and a transmission determining module configured to obtain a performance estimating parameter including a parameter about actual transmission characteristics of each of one or a plurality of low-power base stations for both cases of normal base station without transmission and normal base station with transmission, use the performance estimating parameter and the user scheduling result of the normal base station as a basis to determine weighting throughputs of all the transmission points for the case of normal base station without transmission and weighting throughputs of all the transmission points for the case of normal base station with transmission, and compare the weighting throughputs of all the transmission points to obtain a transmission determination result.

The base station further comprises a performance estimating module configured to receive feedback information of users of the one or plurality of low-power base stations, perform user scheduling of the low-power base stations for the case of normal base station without transmission to obtain a first user set A_{Pj}, perform user scheduling of the low-power base stations for the case of normal base station with transmission to obtain a second user set B_{Pj}, perform performance estimation on the first user set A_{Pj} and second user set B_{Pj}, and obtain an appropriate performance estimating parameter.

The base station further comprises a transmission switch configured to switch on or off data transmission of the normal base station based on the transmission determination result.

The transmission determining module is configured to determine the weighting throughputs of all the transmission points for the case of normal base station without transmission by using an equation:

$${\sum }_{j = 1}^{{N}_{PeNB}} {\sum }_{i ∈ {A}_{{p}_{j}}} \frac{{R}_{{p}_{j} , i}^{′} ( t )}{{\overline{R}}_{{p}_{j} , i} ( t ) \cdot {N}_{{p}_{j}}} or {\sum }_{j = 1}^{{N}_{PeNB}} {\sum }_{i ∈ {A}_{{p}_{j}}} \frac{{R}_{{p}_{j} , i}^{′} ( t )}{{\overline{R}}_{{p}_{j} , i} ( t ) \cdot f ( {N}_{{p}_{j}} )}$$

and determine the weighting throughputs of all the transmission points for the case of normal base station with transmission by using an equation:

$${\sum }_{i ∈ {M}_{m}} \frac{{R}_{m , i} ( t )}{{\overline{R}}_{m , i} ( t ) \cdot {N}_{m}} + {\sum }_{j = 1}^{{N}_{PeNB}} {\sum }_{i ∈ {B}_{{p}_{j}}} \frac{{R}_{{p}_{j} , i} ( t )}{{\overline{R}}_{{p}_{j} , i} ( t ) \cdot {N}_{{p}_{j}}} or$$

$${\sum }_{i ∈ {M}_{m}} \frac{{R}_{m , i} ( t )}{{\overline{R}}_{m , i} ( t ) \cdot f ( {N}_{m} )} + {\sum }_{j = 1}^{{N}_{PeNB}} {\sum }_{i ∈ {B}_{{p}_{j}}} \frac{{R}_{{p}_{j} , i} ( t )}{{\overline{R}}_{{p}_{j} , i} ( t ) \cdot f ( {N}_{{p}_{j}} )}$$

where t denotes a current time, denotes a user number of the normal base station or each of the one or plurality of low-power base stations, j denotes a low-power base station number, Pⱼ denotes a j-th low-power base station, N_{PeNB} denotes a number of low-power base stations, Nₘ denotes a number of users of the normal base station, f(Nₘ) denotes a function of Nₘ, N_{Pj} denotes a number of users of the j-th low-power base station, f(N_{Pj}) is a function of N_{Pj}, Rₚ_{ⱼ}_{,i}′ denotes a throughput of an i-th user in an appropriate user set of the j-th low-power base station for the case of normal base station without transmission, Rₚ_{ⱼ}_{,i}(t) denotes a throughput of the i-th user in an appropriate user set of the j-th low-power base station for the case of normal base station with transmission, R̅Rₚ_{ⱼ}_{,i} denotes an average throughput of the i-th user in an appropriate user set of the j-th low-power base station, R_{m,i} denotes a throughput of an i-th user in an appropriate user set of the normal base station, R̅_{m,i} denotes an average throughput of the i-th user in an appropriate user set of the normal base station, A_{Pj} denotes a first user set scheduled by the j-th low-power base station for the case of normal base station without transmission, B_{Pj} denotes a second user set scheduled by the j-th low-power base station for the case of normal base station with transmission, Mₘ denotes a normal base station user set scheduled by the normal base station.

The transmission determining module is configured to determine the weighting throughputs of all the transmission points for the case of normal base station without transmission by using an equation:

$${\sum }_{j = 1}^{{N}_{PeNB}} {\sum }_{i ∈ {A}_{{p}_{j}}} \frac{{R}_{{p}_{j} , i}^{′} ( t )}{{\overline{C}}_{{p}_{j}} ( t )} or {\sum }_{j = 1}^{{N}_{PeNB}} {\sum }_{i ∈ {A}_{{p}_{j}}} \frac{{R}_{{p}_{j} , i}^{′} ( t )}{f ( {\overline{C}}_{{p}_{j}} ( t ) )}$$

and determine the weighting throughputs of all the transmission points for the case of normal base station with transmission by using an equation:

$${\sum }_{i ∈ {M}_{m}} \frac{{R}_{m , i} ( t )}{{\overline{C}}_{m , i} ( t )} + {\sum }_{j = 1}^{{N}_{PeNB}} {\sum }_{i ∈ {B}_{{p}_{j}}} \frac{{R}_{{p}_{j} , i} ( t )}{{\overline{C}}_{{p}_{j} , i} ( t )} or$$

$${\sum }_{i ∈ {M}_{m}} \frac{{R}_{m , i} ( t )}{f ( {\overline{C}}_{m , i} ( t ) )} + {\sum }_{j = 1}^{{N}_{PeNB}} {\sum }_{i ∈ {B}_{{p}_{j}}} \frac{{R}_{{p}_{j} , i} ( t )}{f ( {\overline{C}}_{{p}_{j} , i} ( t ) )}$$

where t denotes a current time, i denotes a user number of the normal base station or each of the one or plurality of low-power base stations, j denotes a low-power base station number, Pⱼ denotes a j-th low-power base station, N_{PeNB}, denotes a number of low-power base stations, Rₚ_{ⱼ}_{,i}′ denotes a throughput of an i th user in an appropriate user set of the j-th low-power base station for the case of normal base station without transmission, Rₚ_{ⱼ}_{,i} denotes an average throughput of the i-th user in an appropriate user set of the j-th low-power base station, R_{m,i} denotes a throughput of an i-th user in an appropriate user set of the normal base station, C̅ₚ_{ⱼ} denotes an average throughput of the j-th low-power base station, f( C̅ₚ_{ⱼ}(t)) is a function of C̅ₚ_{ⱼ}, C̅ₘ denotes an average throughput of the normal base station, f( C̅ₘ(t)) is a function of C̅ₘ, A_{Pj} denotes a first user set scheduled by the j-th low-power base station for the case of normal base station without transmission, B_{Pj} denotes a second user set scheduled by the j-th low-power base station for the case of normal base station with transmission, Mₘ denotes a normal base station user set scheduled by the normal base station.

The base station further comprises a transmission storing module configured to store frame number information of the normal base station, and the transmission determining module is configured to determine the weighting throughputs of all the transmission points for the case of normal base station without transmission by using an equation:

$$( {\sum }_{j = 1}^{{N}_{PeNB}} {\sum }_{i ∈ {A}_{{P}_{j}}} {R}_{{p}_{j} , i}^{′} ( t ) ) \cdot ( T - {T}_{m} ) or ( {\sum }_{j = 1}^{{N}_{PeNB}} {\sum }_{i ∈ {A}_{{P}_{j}}} {R}_{{p}_{j} , i}^{′} ( t ) ) \cdot {f}_{1} ( T , {T}_{m} , {T}_{n} )$$

and determine the weighting throughputs of all the transmission points for the case of normal base station with transmission by using an equation:

$$( {\sum }_{i ∈ {M}_{m}}^{ } {R}_{m , i} ( t ) + {\sum }_{j = 1}^{{N}_{PeNB}} {\sum }_{i ∈ {B}_{{P}_{j}}}^{ } {R}_{{p}_{j} , i} ( t ) ) \cdot ( T - {T}_{n} )$$

$$or \\ ( {\sum }_{i ∈ {M}_{m}}^{ } {R}_{m , i} ( t ) + {\sum }_{j = 1}^{{N}_{PeNB}} {\sum }_{i ∈ {B}_{{P}_{j}}}^{ } {R}_{{p}_{j} , i} ( t ) ) \cdot {f}_{2} ( T , {T}_{m} , {T}_{n} )$$

where t denotes a current time, i denotes a user number of the normal base station or each of the one or plurality of low-power base stations, j denotes a low-power base station number, Pⱼ denotes a j-th low-power base station, N_{PeNB} denotes a number of low-power base stations, Rₚ_{ⱼ}_{,i}′ denotes a throughput of an i-th user in an appropriate user set of the j-th low-power base station for the case of normal base station without transmission, Rₚ_{ⱼ}_{,i}(t) denotes a throughput of the i-th user in an appropriate user set of the j-th low-power base station for the case of normal base station with transmission, R_{m,i} denotes a throughput of an i-th user in an appropriate user set of the normal base station, A_{Pj} denotes a first user set scheduled by the j-th low-power base station for the case of normal base station without transmission, B_{Pj} denotes a second user set scheduled by the j-th low-power base station for the case of normal base station with transmission, T denotes a total number of frames, Tₘ denotes a number of frames without transmission of the normal base station, Tₙ denotes a number of frames with transmission of the normal base station, f₁(T, Tₘ, Tₙ) and f₂(T, Tₘ, Tₙ) both denote functions of T, Tₘ, Tₙ.

The base station further comprises a transmission storing module configured to store frame number information of the normal base station, and the transmission determining module is configured to determine the weighting throughputs of all the transmission points for the case of normal base station without transmission by using an equation:

$$( {\sum }_{j = 1}^{{N}_{PeNB}} {\sum }_{i ∈ {A}_{{P}_{j}}}^{ } \frac{{R}_{{p}_{j} , i}^{′} ( t )}{{\overline{R}}_{{p}_{j} , i} ( t )} ) \cdot ( T - {T}_{m} )$$

$$or \\ ( {\sum }_{j = 1}^{{N}_{PeNB}} {\sum }_{i ∈ {A}_{{P}_{j}}}^{ } \frac{{R}_{{p}_{j} , i}^{′} ( t )}{{\overline{R}}_{{p}_{j} , i} ( t )} ) \cdot {f}_{1} ( T , {T}_{m} , {T}_{n} )$$

and determine the weighting throughputs of all the transmission points for the case of normal base station with transmission by using an equation:

$$( {\sum }_{i ∈ {M}_{m}}^{ } \frac{{R}_{m , i} ( t )}{{\overline{R}}_{m , i} ( t )} + {\sum }_{j = 1}^{{N}_{PeNB}} {\sum }_{i ∈ {B}_{{P}_{j}}}^{ } \frac{{R}_{{p}_{j} , i}^{′} ( t )}{{\overline{R}}_{{p}_{j} , i} ( t )} ) \cdot ( T - {T}_{n} )$$

$$or \\ ( {\sum }_{i ∈ {M}_{m}}^{ } \frac{{R}_{m , i} ( t )}{{\overline{R}}_{m , i} ( t )} + {\sum }_{j = 1}^{{N}_{PeNB}} {\sum }_{i ∈ {B}_{{P}_{j}}}^{ } \frac{{R}_{{p}_{j} , i} ( t )}{{\overline{R}}_{{p}_{j} , i} ( t )} ) \cdot {f}_{2} ( T , {T}_{m} , {T}_{n} )$$

where t denotes a current time, denotes a user number of the normal base station or each of the one or plurality of low-power base stations, j denotes a low-power base station number, Pⱼ denotes a j-th low-power base station, N_{PeNB} denotes a number of low-power base stations, Rₚ_{ⱼ}_{,i}′ denotes a throughput of an i-th user in an appropriate user set of the j-th low-power base station for the case of normal base station without transmission, Rₚ_{ⱼ}_{,i}(t) denotes a throughput of the i-th user in an appropriate user set of the j-th low-power base station for the case of normal base station with transmission, R̅ₚ_{ⱼ}_{,i} denotes an average throughput of the i-th user in an appropriate user set of the j-th low-power base station, R_{m,i} denotes a throughput of an i-th user in an appropriate user set of the normal base station, R̅_{m,i} denotes an average throughput of the i-th user in an appropriate user set of the normal base station, A_{Pj} denotes a first user set scheduled by the j-th low-power base station for the case of normal base station without transmission, B_{Pj} denotes a second user set scheduled by the j-th low-power base station for the case of normal base station with transmission, T denotes a total number of frames, Tₘ denotes a number of frames without transmission of the normal base station, Tₙ denotes a number of frames with transmission of the normal base station, f₁(T, Tₘ, Tₙ) and f₂(T, Tₘ, Tₙ) both denote functions of T, Tₘ, Tₙ.

The transmission determining module is configured to determine the weighting throughputs of all the transmission points for the case of normal base station without transmission by using an equation:

$${\sum }_{j = 1}^{{N}_{PeNB}} {\sum }_{i ∈ {A}_{{P}_{j}}}^{ } \frac{{R}_{{p}_{j} , i}^{′} ( t )}{{W}_{{p}_{j} , i} ( t )}$$

$$or$$

$${\sum }_{j = 1}^{{N}_{PeNB}} {\sum }_{i ∈ {A}_{{P}_{j}}}^{ } \frac{{R}_{{p}_{j} , i}^{′} ( t )}{f ( {W}_{{p}_{j} , i} ( t ) )}$$

and determine the weighting throughputs of all the transmission points for the case of normal base station with transmission by using an equation:

$${\sum }_{i ∈ {M}_{m}}^{ } \frac{{R}_{m , i} ( t )}{{W}_{m , i} ( t )} + {\sum }_{j = 1}^{{N}_{PeNB}} {\sum }_{i ∈ {B}_{{P}_{j}}}^{ } \frac{{R}_{{p}_{j} , i} ( t )}{{W}_{{p}_{j} , i} ( t )}$$

$$or$$

$${\sum }_{i ∈ {M}_{m}}^{ } \frac{{R}_{m , i} ( t )}{f ( {W}_{m , i} ( t ) )} + {\sum }_{j = 1}^{{N}_{PeNB}} {\sum }_{i ∈ {B}_{{P}_{j}}}^{ } \frac{{R}_{{p}_{j} , i} ( t )}{f ( {W}_{{p}_{j} , i} ( t ) )}$$

where W_{Pj,i}(t) denotes a total amount of data to transmit to an i-th user in an appropriate user set of a j-th low-power base station, f(W_{Pj,i}(t)) denotes a function of W_{Pj,i}(t), W_{m,i}(t) denotes a total amount of data to transmit to an i-th user in an appropriate user set of the normal base station, and f(W_{m,i}(t)) denotes a function of W_{m,i}(t).

The transmission determining module is configured to determine the weighting throughputs of all the transmission points for the case of normal base station without transmission by using an equation:

$${\sum }_{j = 1}^{{N}_{PeNB}} {\sum }_{i ∈ {A}_{{P}_{j}}}^{ } ( {R}_{{p}_{j} , i}^{′} ( t ) \cdot {S}_{{p}_{j} , i} ( t ) )$$

$$or$$

$${\sum }_{j = 1}^{{N}_{PeNB}} {\sum }_{i ∈ {A}_{{P}_{j}}}^{ } ( {R}_{{p}_{j} , i}^{′} ( t ) \cdot f ( {S}_{{p}_{j} , i} ( t ) ) )$$

and determine the weighting throughputs of all the transmission points for the case of normal base station with transmission by using an equation:

$${\sum }_{i ∈ {M}_{m}}^{ } ( {R}_{m , i} ( t ) \cdot {S}_{m , i} ( t ) ) + {\sum }_{j = 1}^{{N}_{PeNB}} {\sum }_{i ∈ {B}_{{P}_{j}}}^{ } ( {R}_{{p}_{j} , i} ( t ) \cdot {S}_{{p}_{j} , i} ( t ) )$$

$$or$$

$${\sum }_{i ∈ {M}_{m}}^{ } ( {R}_{m , i} ( t ) \cdot f ( {S}_{m , i} ( t ) ) ) + {\sum }_{j = 1}^{{N}_{PeNB}} {\sum }_{i ∈ {B}_{{P}_{j}}}^{ } ( {R}_{{p}_{j} , i} ( t ) \cdot f ( {S}_{{p}_{j} , i} ( t ) ) )$$

where S_{Pj,i}(t) denotes a total amount of data to transmit to an i-th user in an appropriate user set of a j-th low-power base station, f(S_{Pj,i}(t)) denotes a function of S_{Pj,i}(t), S_{m,i}(t) denotes a total amount of data to transmit to an i-th user in an appropriate user set of the normal base station, and f(S_{m,i}(t)) denotes a function of S_{m,i}(t).

The present invention further provides a radio network comprising: a normal base station configured to perform scheduling based on feedback information of users of the normal base station to obtain a user scheduling result of the normal base station including a parameter about actual transmission characteristics of the normal base station, obtain a performance estimating parameter including a parameter about actual transmission characteristics of each of one or a plurality of low-power base stations within coverage of the normal base station for both cases of normal base station without transmission and normal base station with transmission, use the performance estimating parameter and the user scheduling result of the normal base station as a basis to determine weighting throughputs of all the transmission points for the case of normal base station without transmission and weighting throughputs of all the transmission points for the case of normal base station with transmission, compare the weighting throughputs of all the transmission points to obtain a transmission determination result and perform data transmission based on the transmission determination result; and the one or a plurality of low-power base stations each configured to perform pre-scheduling based on feedback information of users of own station to obtain a first user set A_{Pj} for the case of normal base station without transmission and a second user set B_{Pj} for the case of normal base station with transmission, perform performance estimation on each of the first user set A_{Pj} and the second user set B_{Pj} and feed obtained performance estimating parameters back to the normal base station.

The normal base station is configured to feed the transmission determination result to the one or plurality of low-power base stations; and each of the one or plurality of low-power base stations is configured to use the transmission determination result as a basis to determine an appropriate user set out of the first user set A_{Pj} and the second user set B_{Pj} and performs data transmission.

The present invention further provides a method for coordinating inter-cell interference in a radio network including a normal base station and one or a plurality of low-power base stations within coverage of the normal base station as transmission points, the method comprising: a step A of the normal base station determining a throughput of the normal base station at a first time t1 based on a transmission determination result at a current time; a step B of the normal base station obtaining a throughput of each of the one or plurality of low-power base stations at the first time t1; and a step C of the normal base station compares throughputs of all transmission points at the first time t1 and throughputs of all the transmission points at a second time t2 prior to the first time t, determines a transmission determination result at a next time t+1 based on a comparison result, and using the transmission determination result as a basis to allow an operation in accordance with a case of normal base station without transmission or a case of normal base station with transmission to be executed at the next time t+1.

In the step A, when the transmission determination result at the current time t is a result of normal base station without transmission, the normal base station sets an estimated throughput Cₘ(t) at the current time t to 0, and when the transmission determination result at the current time t is a result of normal base station with transmission, the normal base station performs user scheduling of the normal base station and obtains an estimated throughput Cₘ(t) at the current time t.

In the step B, when the transmission determination result at the current time t is a result of normal base station without transmission, the normal base station performs user scheduling of each of the one or plurality of low-power base stations in accordance with the case of normal base station without transmission and obtains a sum of estimated throughputs of the one or plurality of low-power base stations at the current time t:

$${\sum }_{j = 1}^{{N}_{PeNB}} {C}_{{p}_{j}} ( t )$$

and when the transmission determination result at the current time t is a result of normal base station with transmission, the normal base station performs user scheduling of each of the one or plurality of low-power base stations in accordance with the case of normal base station with transmission and obtains a sum of estimated throughputs of the one or plurality of low-power base stations at the current time t:

$${\sum }_{j = 1}^{{N}_{PeNB}} {C}_{{p}_{j}} ( t ) .$$

In the step B, when the transmission determination result at the current time t is a result of normal base station without transmission, each of the one or plurality of low-power base stations performs user scheduling of the low-power base station in accordance with the case of normal base station without transmission, obtains an estimated throughput C_{Pj}(t) of own station at the current time t and transmits the estimated throughput to the normal base station, and when the transmission determination result at the current time t is a result of normal base station with transmission, each of the one or plurality of low-power base stations performs user scheduling of the low-power base station in accordance with the case of normal base station with transmission, obtains an estimated throughput C_{Pj}(t) of own station at the current time t and transmits the estimated throughput to the normal base station.

In the step C, the normal base station compares a total estimated throughput at the current time t:

$${C}_{m} ( t ) + {\sum }_{j = 1}^{{N}_{PeNB}} {C}_{{p}_{j}} ( t )$$

with a total estimated throughput at a previous time t−1:

$${C}_{m} ( t - 1 ) + {\sum }_{j = 1}^{{N}_{PeNB}} {C}_{{p}_{j}} ( t - 1 ) ,$$

when

$${C}_{m} ( t ) + {\sum }_{j = 1}^{{N}_{PeNB}} {C}_{{p}_{j}} ( t )$$

is greater than

$${C}_{m} ( t - 1 ) + {\sum }_{j = 1}^{{N}_{PeNB}} {C}_{{p}_{j}} ( t - 1 ) ,$$

the normal base station sets a transmission determination result at the next time t+1 to be identical with the transmission determination result at the current time 1,
when

$${C}_{m} ( t ) + {\sum }_{j = 1}^{{N}_{PeNB}} {C}_{{p}_{j}} ( t )$$

is not greater than

$${C}_{m} ( t - 1 ) + {\sum }_{j = 1}^{{N}_{PeNB}} {C}_{{p}_{j}} ( t - 1 ) ,$$

the normal base station sets the transmission determination result at the next time t+1 to be opposite to the transmission determination result at the current time 1.

In the step C, the normal base station compares an actual throughput at a first time t−τ:

$${\sum }_{i} ( {D}_{m , i} ( t - τ ) \cdot {AN}_{m , i} ( t - τ ) ) + {\sum }_{j = 1}^{{N}_{PeNB}} {\sum }_{i} ( {D}_{{P}_{j} , i} ( t - τ ) \cdot {AN}_{{P}_{j} , i} ( t - τ ) )$$

with an actual throughput at a second time t−τ−1:

$${\sum }_{i} ( {D}_{m , i} ( t - τ - 1 ) \cdot {AN}_{m , i} ( t - τ - 1 ) ) + {\sum }_{j = 1}^{{N}_{PeNB}} {\sum }_{i} ( {D}_{{P}_{j} , i} ( t - τ - 1 ) \cdot {AN}_{{P}_{j} , i} ( t - τ - 1 ) ) ,$$

when the actual throughput at the first time t−τ is greater than the actual throughput at the second time t−τ−1, the normal base station sets a transmission determination result at the next time t+1 to be identical with the transmission determination result at the current time t, and
when the actual throughput at the first time t−τ is not greater than the actual throughput at the second time t−τ−1, the normal base station sets the transmission determination result at the next time t+1 to be opposite to the transmission determination result at the current time t,
where D_{m,i} denotes an actual amount of transmission data of an i-th user of the normal base station, D_{Pj,i} denotes an actual amount of transmission data of an i-th user of an j-th low-power base station, AN_{m,i} denotes proper reception indication information of corresponding data of the i-th user of the normal base station, AN_{Pj,i} denotes proper reception indication information of corresponding data of the i-th user of the j-th low-power base station, and T denotes a feedback time delay of proper reception indication information.

### Advantageous Effects of Invention

By adopting the method, the base station and the radio network provided by the embodiments of the present invention, it is possible to ensure better performance of inter-cell interference coordination.

### BRIEF DESCRIPTION OF DRAWINGS

FIG. 1 is a flowchart of a method for coordinating inter-cell interference in a heterogeneous network according to one embodiment of the present invention;

FIG. 2 is a flowchart of a method for coordinating inter-cell interference in a heterogeneous network according to one embodiment of the present invention;

FIG. 3 is a flowchart of a method for coordinating inter-cell interference in a heterogeneous network according to one embodiment of the present invention;

FIG. 4 is a flowchart of a method for coordinating inter-cell interference in a heterogeneous network according to one embodiment of the present invention;

FIG. 5 is a flowchart of a method for coordinating inter-cell interference in a heterogeneous network according to one embodiment of the present invention;

FIG. 6 is a flowchart of a method for coordinating inter-cell interference in a heterogeneous network according to one embodiment of the present invention;

FIG. 7 is a flowchart of a method for coordinating inter-cell interference in a heterogeneous network according to one embodiment of the present invention;

FIG. 8 is a flowchart of a method for coordinating inter-cell interference in a heterogeneous network according to one embodiment of the present invention;

FIG. 9 is a flowchart of a method for coordinating inter-cell interference in a heterogeneous network according to one embodiment of the present invention;

FIG. 10 is a flowchart of a method for coordinating inter-cell interference in a heterogeneous network according to one embodiment of the present invention;

FIG. 11 is a diagram illustrating a configuration of a normal base station according to one embodiment of the present invention;

FIG. 12 is a diagram illustrating a configuration of a normal base station according to one embodiment of the present invention; and

FIG. 13 is a diagram illustrating a configuration of a normal base station according to one embodiment of the present invention.

### DESCRIPTION OF EMBODIMENTS

In order to further clarify an objective, solving means and merits of the present invention, the present invention will be described in detail below, with reference to the drawings and by way of embodiments.

In the dynamic inter-cell interference coordination (eICIC), the open or closed state of the macro base station is determined dynamically per TTI or over a plurality of TTIs. Therefore, eICIC can provide improved performance as compared with the semi-static eICIC. In determining the open or closed state of the macro base station, according to eICIC, it is necessary to compare “macro base station without transmission (macro mute)” with “macro base station with transmission (macro non-mute)” as to cell performance. As a matter to be explained, the closed state of the macro base station corresponds to the macro base station without transmission (macro mute), while the open state of the macro base station corresponds to the macro base station with transmission (macro non-mute). In order to guarantee fairness in performance comparison, each of transmission points or base stations in a heterogeneous network (for example, normal base station such as macro base station or low-power base station such as pico base station) adopts proportional fair (PF) algorithm within its own cell to conduct scheduling of the own cell. When performing muting decision, the macro base station compares the macro mute case with the macro non-mute case as to a total sum of priorities of all the transmission points after proportional fair scheduling and selects a higher-priority case.

Specifically, the present invention provides a method for coordinating inter-cell interference in a radio network. The radio network includes the following transmission points, such as a normal base station and one or a plurality of low-power base stations located within a cover area of the normal base station. The method comprises:

a step A of the normal base station performing scheduling based on feedback information of users of the normal base station and obtaining a user scheduling result of the normal base station containing a parameter relating to actual transmission characteristics of the normal base station;

a step B of the normal base station obtaining performance estimating parameters including a parameter relating to actual transmission characteristics of each of the low-power base stations in each of a case of normal base station without transmission (mute case) and a case of normal base station with transmission (non-mute case);

a step C of using the performance estimating parameters and the user scheduling result of the normal base station as a basis to determine weighting throughputs of all transmission points in the case of normal base station without transmission and weighing throughputs of all the transmission points in the case of normal base station with transmission; and

a step D of the normal base station comparing the weighting throughputs with each other to obtain a transmission determination result and performing data transmission based on the transmission determination result.

Here, the radio network may be a heterogeneous network or any other network.

As matter to be explained, the actual transmission characteristics of different transmission points may be represented by the number of users connected to each of the transmission points, a total sum of throughputs of all the users at each of the transmission points, information of the number of frames for the normal base station with and without transmission, a total amount of data to transmit to each user at each transmission point, a total amount of data to transmit from each user at each transmission point, or any of the above-mentioned parameters. As is clear from this, as the transmission determination result provided by the embodiment of the present invention is given considering the actual transmission characteristics of the different transmission points, it can be a fair and reasonable one. This makes it possible to assure better inter-cell interference coordination performance.

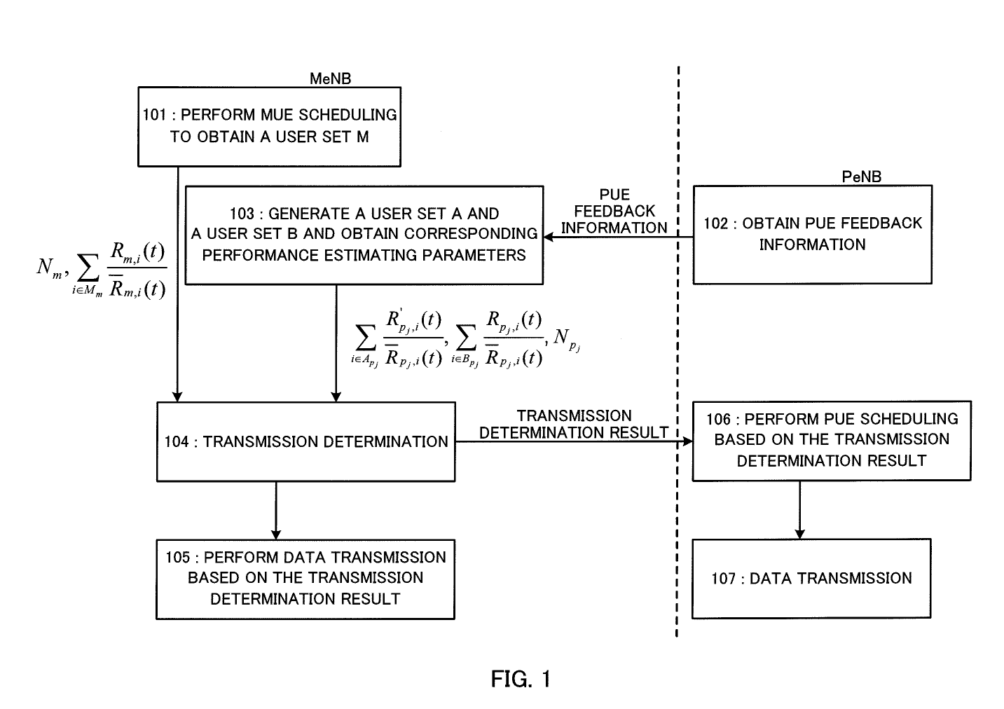

FIG. 1 illustrates a method for coordinating inter-cell interference in a heterogeneous network according to one embodiment of the present invention. This method includes the following steps.

In the step 101, the macro base station (MeNB) performs scheduling based on feedback information of a macro base station user (MUE) and obtains a user set M. Here, the step 101 can be executed by a MUE scheduling module provided in the MeNB, and the user set M includes the MUE scheduled by the MeNB.

In the step 102, the pico base station (PeNB) obtains feedback information of a pico base station user (PUE) and provides it to the MeNB.

More specifically, the feedback information of the PUE may include a channel quality indicator (CQI), a precoding matrix indicator (PMI) of the PUE, and so on.

In the step 103, the MeNB performs scheduling for each PeNB in both of the case of macro base station without transmission (MeNB mute) and the case of macro base station with transmission (MeNB non-mute). Then, the MeNB generates a user set A and a user set B and performs performance estimation on each of the two user sets thereby to obtain corresponding performance estimating parameters.

More specifically, the user set A includes PUE scheduled by the PeNB in the case of MeNB mute. The user set is such as determined based on the feedback information of all PUE apparatuses in the case of MeNB mute. The user set B includes PUE scheduled by the PeNB in the case of MeNB non-mute. The user set is such as determined based on feedback information of all PUE apparatuses in the case of MeNB non-mute. And, the performance estimating parameters may include at least one of the following parameters:

a weighting sum of throughputs for all the users in the user set A (which is also called weighting throughput for the case of macro base station without transmission of the PeNB)

$${\sum }_{i ∈ {A}_{{p}_{j}}} \frac{{R}_{{p}_{j} , i}^{′} ( t )}{{\overline{R}}_{{p}_{j} , i} ( t )} ,$$

a weighting sum of throughputs for all the users in the user set B (which is also called weighting throughput for the case of macro base station with transmission of the PeNB)

$${\sum }_{i ∈ {B}_{{p}_{j}}} \frac{{R}_{{p}_{j} , i} ( t )}{{\overline{R}}_{{p}_{j} , i} ( t )} ,$$

and

a number of connected users N_{Pj} (indicating the number of PUE apparatuses connected to the j-th PeNB). Here, t denotes a current time, i denotes a user number, j denotes a PeNB number, Pⱼ denotes the j-th PeNB, A_{Pj} denotes a user set A of the j-th PeNB, B_{Pj} denotes a user set B of the j-th PeNB, Rₚ_{ⱼ}_{,i}′ denotes a throughput of the i-th user in the corresponding user set of the j-th PeNB in the case of macro base station without transmission, Rₚ_{ⱼ}_{,i} is a throughput of the i-th user in the corresponding user set of the j-th PeNB in the case of macro base station with transmission, R̅ₚ_{ⱼ}_{,i} denotes an average throughput of the i-th user in the corresponding user set of the j-th PeNB. Besides, the step 103 can be executed by a PUE performance estimating module provided in the MeNB.

In the step 104, the MeNB compares the priority for MeNB mute with the priority for MeNB non-mute based on the performance estimating parameters of one or a plurality of PeNB apparatuses in the coverage of the MeNB and the MUE scheduling result by the MeNB. The MeNB obtains a transmission determination result based on the priority comparison. For example, when the priority is higher in the case of macro base station without transmission, the transmission determination result may be such that the MeNB does not transmit data, and otherwise, the transmission determination result may be such that the MeNB transmits data.

Here, the step 104 may be executed by a transmission determining module provided in the MeNB. And, in the step 104, the PUE performance estimating module may be used to transmit performance estimating parameters of one or a plurality of PeNB apparatuses to the transmission determining module, and the MUE scheduling module may transmit, to the transmission determining module, at least one of a weighting sum of throughputs of all users scheduled by the MeNB (which is also called weighting throughput for the case of macro base station with transmission of the MeNB)

$${\sum }_{i ∈ {M}_{m}} \frac{{R}_{m , i} ( t )}{{\overline{R}}_{m , i} ( t )} ,$$

and a number of connected users Nₘ (which is also called a number of MUE apparatuses).
Here, the Mₘ denotes a user set M of users scheduled by the MeNB, R_{m,i} denotes a throughput of the i-th user in the corresponding user set of the MeNB in the case of the macro base station with transmission, R̅_{m,i} is an average throughput of the i-th user in the corresponding user set of the MeNB.

More specifically, one priority calculation method in the case of MeNB mute is presented as follows. That is, the priority in the case of MeNB mute is obtained by dividing weighting throughputs for MeNB mute of each of all PeNB apparatuses by the number of PUE apparatuses of the corresponding PeNB and adding up the resulting values.

$${\sum }_{j = 1}^{{N}_{PeNB}} {\sum }_{i ∈ {A}_{{p}_{j}}} \frac{{R}_{{p}_{j} , i}^{′} ( t )}{{\overline{R}}_{{p}_{j} , i} ( t ) \cdot {N}_{{p}_{j}}}$$

$$or$$

$${\sum }_{j = 1}^{{N}_{PeNB}} {\sum }_{i ∈ {A}_{{p}_{j}}} \frac{{R}_{{p}_{j} , i}^{′} ( t )}{{\overline{R}}_{{p}_{j} , i} ( t ) \cdot f ( {N}_{{p}_{j}} )}$$

Here, N_{PeNB} is the number of PeNB apparatuses and f(N_{Pj}) is a function of N_{Pj}.

One priority calculation method in the case of MeNB non-mute is presented as follows. That is, the priority in the case of MeNB non-mute is obtained by dividing weighting throughputs for MeNB non-mute of each of all PeNB apparatuses by the number of PUE apparatuses of the corresponding PeNB, adding up the values and adding to the sum a value obtained by dividing a weighting throughput of MeNB non-mute of the MeNB by the number of MUE apparatuses of the MeNB.

$${\sum }_{i ∈ {M}_{m}} \frac{{R}_{m , i} ( t )}{{\overline{R}}_{m , i} ( t ) \cdot {N}_{m}} + {\sum }_{j = 1}^{{N}_{PeNB}} {\sum }_{i ∈ {B}_{{p}_{j}}} \frac{{R}_{{p}_{j} , i} ( t )}{{\overline{R}}_{{p}_{j} , i} ( t ) \cdot {N}_{{p}_{j}}}$$

$$or$$

$${\sum }_{i ∈ {M}_{m}} \frac{{R}_{m , i} ( t )}{{\overline{R}}_{m , i} ( t ) \cdot f ( {N}_{m} )} + {\sum }_{j = 1}^{{N}_{PeNB}} {\sum }_{i ∈ {B}_{{p}_{j}}} \frac{{R}_{{p}_{j} , i} ( t )}{{\overline{R}}_{{p}_{j} , i} ( t ) \cdot f ( {N}_{{p}_{j}} )}$$

Here, f(Nₘ) is a function of Mₘ.

In the step 105, the transmission determining module transmits a transmission determination result to a transmission switch in the MeNB. With this transmission, data transmission by the MeNB can be controlled appropriately.

In the step 106 to 107, the transmission determining module of the MeNB feeds a transmission determination result back to one or a plurality of PeNB apparatuses, and each PeNB performs PUE scheduling based on the received result and executes corresponding data transmission.

As a matter to be explained, in the flowchart illustrated in FIG. 1 or following different embodiments, the processing order of the steps is not necessarily determined. For example, execution of the steps 102 and 103 and execution of the step 101 are independent from each other and are conducted irrespective of the order. Likewise, execution of the steps 106 and 107 and execution of the step 105 are performed irrespective of the processing order.

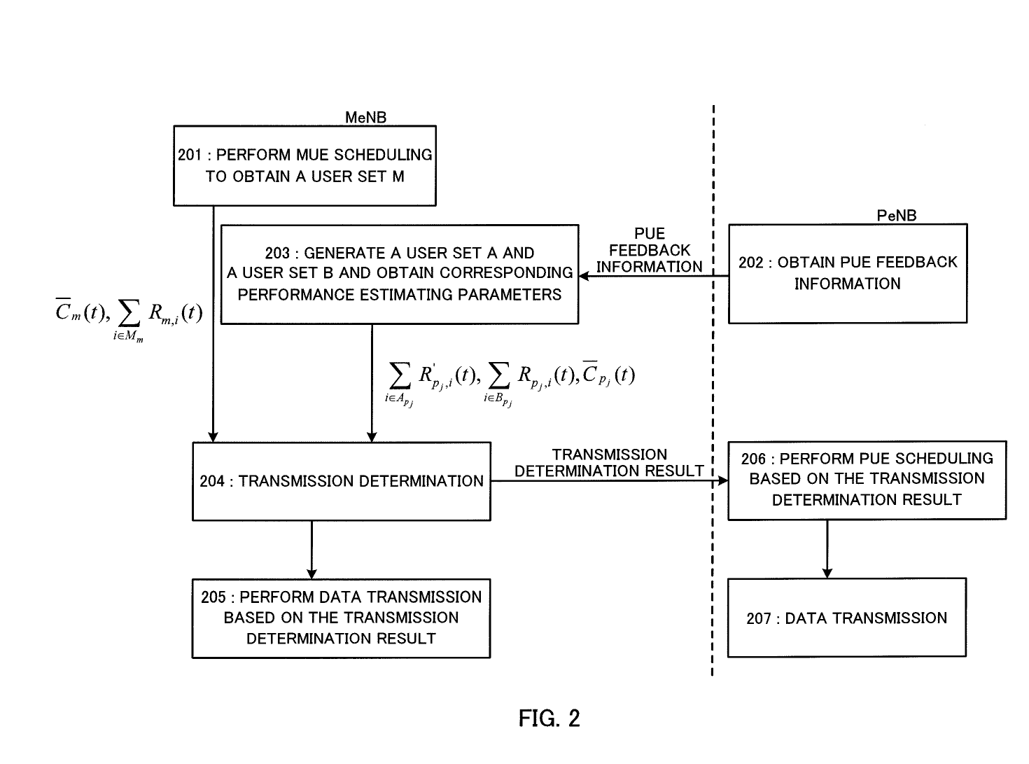

FIG. 2 also illustrates a method for coordinating inter-cell interference in a heterogeneous network in one embodiment of the present invention.

Here, the steps 201 to 204 correspond to the steps 101 to 104 in FIG. 1, respectively. That is, the step 201 is similar to the step 101, the step 202 is similar to the step 102, the step 203 is similar to the step 103 and the step 204 is similar to the step 104.

As a matter to be explained, the steps in FIG. 2 are different from the steps in FIG. 1 in the following points.

In the step 201, a MUE scheduling module in the MeNB first performs scheduling based on feedback information of a macro base station user and then, transmits a scheduling result to the transmission determining module in the MeNB. The scheduling result includes at least one of a total sum of throughputs of all users scheduled by the MeNB (which is also called throughput for the case of macro base station with transmission of the MeNB)

$${\sum }_{i ∈ {M}_{m}} {R}_{m , i} ( t ) ,$$

and

an average throughput at a past time of the MeNB C̅ₘ. In the step 203, the PUE performance estimating module of the MeNB performs performance estimation based on the feedback information of the PUE obtained from the PeNB in the step 202, obtains performance estimating parameters of one or a plurality of PeNB apparatuses and provides them to the transmission determining module of the MeNB.

Here, the performance estimating parameter of each PeNB includes at least one of the following parameters:

a total sum of throughputs of all users in the user set A (which is also called throughput for the case of macro base station without transmission of the PeNB)

$${\sum }_{i ∈ {A}_{{P}_{j}}} {R}_{{p}_{j} , i}^{′} ( t ) ,$$

a total sum of throughputs of all users in the user set B (which is called throughput for the case of macro base station with transmission of the PeNB)

$${\sum }_{i ∈ {B}_{{P}_{j}}} {R}_{{p}_{j} , i} ( t ) ,$$

an average throughput at a past time of the PeNB C̅_{Pj}.

In the step 204, the transmission determining module calculates the priorities of both of the MeNB mute case and the MeNB non-mute case in accordance with the following method and obtains a transmission determination result.

Here, the priority calculating method for the MeNB mute case is presented as follows. That is, the priority for the MeNB mute case is obtained by dividing throughputs for the macro base station without transmission of all PeNB apparatuses by a corresponding PeNB average throughput and adding up the values.

$${\sum }_{j = 1}^{{N}_{PeNB}} {\sum }_{i ∈ {A}_{{p}_{j}}} \frac{{R}_{{p}_{j} , i}^{′} ( t )}{{\overline{C}}_{{p}_{j}} ( t )}$$

$$or$$

$${\sum }_{j = 1}^{{N}_{PeNB}} {\sum }_{i ∈ {A}_{{p}_{j}}} \frac{{R}_{{p}_{j} , i}^{′} ( t )}{f ( {\overline{C}}_{{p}_{j}} ( t ) )}$$

The priority calculating method for the MeNB non-mute case is presented as follows. The priority for the MeNB non-mute is obtained by dividing throughputs for the case of macro base station with transmission for all PeNB apparatuses by a corresponding PeNB average throughput, adding up values, and further adding a value obtained by dividing a macro base station with transmission throughput of the MeNB by an average throughput of the MeNB.

$${\sum }_{i ∈ {M}_{m}} \frac{{R}_{m , i} ( t )}{{\overline{C}}_{m} ( t )} + {\sum }_{j = 1}^{{N}_{PeNB}} {\sum }_{i ∈ {B}_{{p}_{j}}} \frac{{R}_{{p}_{j} , i} ( t )}{{\overline{C}}_{{p}_{j}} ( t )}$$

$$or$$

$${\sum }_{i ∈ {M}_{m}} \frac{{R}_{m , i} ( t )}{f ( {\overline{C}}_{m} ( t ) )} + {\sum }_{j = 1}^{{N}_{PeNB}} {\sum }_{i ∈ {B}_{{p}_{j}}} \frac{{R}_{{p}_{j} , i} ( t )}{f ( {\overline{C}}_{{p}_{j}} ( t ) )}$$

Here, f( C̅ₚ_{ⱼ}(t)) is a function of C̅ₚ_{ⱼ}. f( C̅ₘ(t)) is a function of C̅ₘ.

Besides, the steps 205 to 207 are similar to the steps 105 to 107 in FIG. 1, and their explanation is omitted here.

As is clear from this, according to the present embodiment, the transmission determination result considers a total sum of average throughputs of all users at different transmission points. The priorities for the two cases of MeNB mute and MeNB non-mute are determined based on values that are obtained by dividing a throughput after proportional fair scheduling of each of the transmission points (including MeNB and one or a plurality of PeNBs) by a sum of average throughputs of all users of a corresponding transmission point. Needless to say, in the above-mentioned equation,

C̅_{P}_{ⱼ} and C̅ₘ may b replaced with f( C̅ₚ_{ⱼ}) and f( C̅ₘ), respectively.
That is, in determining the priorities, a function of the sum of average throughputs of all users of different transmission points may be considered.

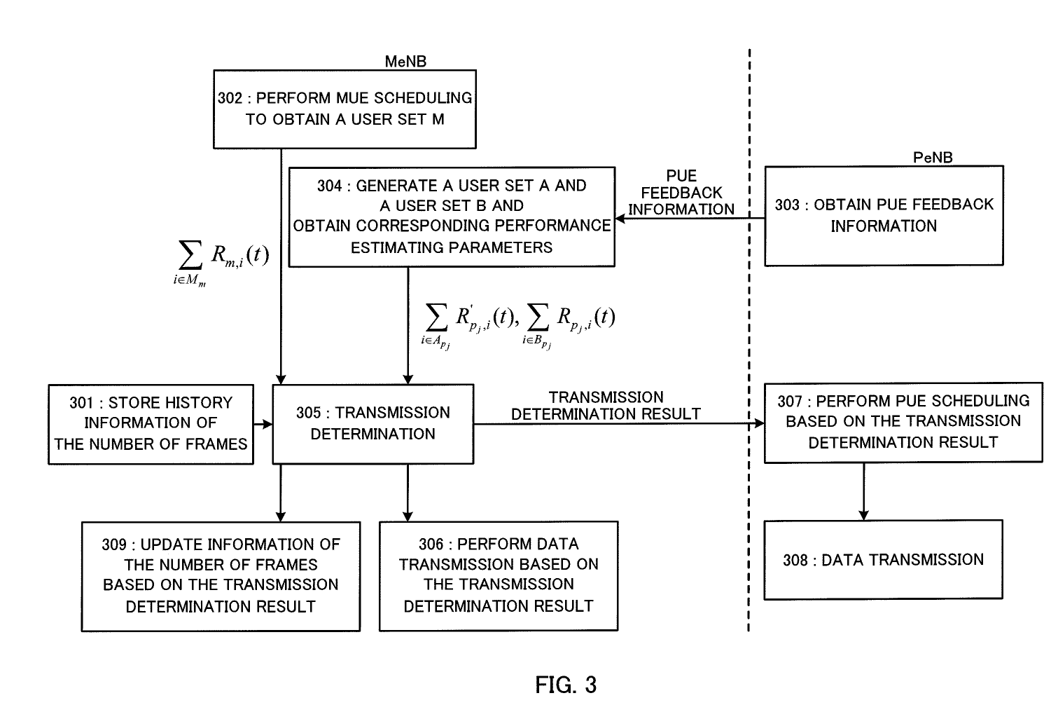

FIG. 3 illustrates a method for coordinating inter-cell interference in a heterogeneous network according to one embodiment of the present invention. The method includes the following steps.

In the step 301, a transmission storing module in the MeNB transmits, to the transmission determining module in the MeNB, at least one of the following frame information, that is, a total number of frames T, a number of frames with transmission Tₙ and a number of frames without transmission Tₘ.

The steps 302 to 305 correspond to the steps 101 to 104 in FIG. 1, respectively.

As a matter to be explained, in the step 302, an MUE scheduling module in the MeNB transmits the following scheduling result to the transmission determining module in the MeNB. Specifically, the scheduling result is a total sum of throughputs of all users scheduled by the MeNB (which is called throughput for the case of macro base station with transmission of the MeNB), which is expressed as follows.

$${\sum }_{i ∈ {M}_{m}} {R}_{m , i} ( t )$$

In the step 304, a PUE performance estimating module of the MeNB performs performance estimation based on feedback information of PUE obtained from the PeNB in the step 303 and transmits performance estimating parameters of one or a plurality of PeNB apparatuses to the transmission determining module of the MeNB.

Specifically, the performance estimating parameter may include at least one of the following parameters, that is, a total sum of throughputs of all users in the user set A (which is also called throughput for the case of macro base station without transmission of the PeNB)

$${\sum }_{i ∈ {A}_{{P}_{j}}} {R}_{{p}_{j} , i}^{′} ( t ) ,$$

and
a total sum of throughputs of all users in the user set B (which is also called throughput for the case of macro base station with transmission of the PeNB)

$${\sum }_{i ∈ {B}_{{P}_{j}}} {R}_{{p}_{j} , i} ( t ) ,$$

In the step 305, the transmission determining module calculates the priorities of the two cases of MeNB mute and MeNB non-mute in accordance with the following method thereby to obtain a transmission determining result.

Specifically, the priority calculating method for the MeNB mute case is presented as follows. That is, the priority for the MeNB mute case is obtained by multiplying a total sum of throughputs for the case of macro base station without transmission of all PeNB apparatuses by a difference between a total number of frames and a number of frames without transmission.

$$( {\sum }_{j = 1}^{{N}_{PeNB}} {\sum }_{i ∈ {A}_{{P}_{j}}}^{ } {R}_{{p}_{j} , i}^{′} ( t ) ) \cdot ( T - {T}_{m} )$$

$$or \\ ( {\sum }_{j = 1}^{{N}_{PeNB}} {\sum }_{i ∈ {A}_{{P}_{j}}}^{ } {R}_{{p}_{j} , i}^{′} ( t ) ) \cdot {f}_{1} ( T , {T}_{m} , {T}_{n} )$$

The priority calculating method for the MeNB non-mute case is presented as follows. That is, the priority for the MeNB non-mute case is obtained by adding up a total sum of macro base station-with transmission of all PeNB apparatuses and a macro base station with transmission throughput of the MeNB and multiplying a resultant value by a difference between the total number of frames and the number of frames with transmission.

$$( {\sum }_{i ∈ {M}_{m}}^{ } {R}_{m , i} ( t ) + {\sum }_{j = 1}^{{N}_{PeNB}} {\sum }_{i ∈ {B}_{{P}_{j}}}^{ } {R}_{{p}_{j} , i} ( t ) ) \cdot ( T - {T}_{n} )$$

$$or \\ ( {\sum }_{i ∈ {M}_{m}}^{ } {R}_{m , i} ( t ) + {\sum }_{j = 1}^{{N}_{PeNB}} {\sum }_{i ∈ {B}_{{P}_{j}}}^{ } {R}_{{p}_{j} , i} ( t ) ) \cdot {f}_{2} ( T , {T}_{m} , {T}_{n} )$$

Here, f₁(T, Tₘ, Tₙ) and f₂(T, Tₘ, Tₙ) are both functions of T, Tₘ and Tₙ.

The steps 306 to 308 are similar to the steps 105 to 107 in FIG. 1, and their explanation is omitted here.

In the step 309, the transmission determining module provides a transmission determining result to the transmission storing module of the MeNB and the transmission storing module updates frame number information.

For example, when the transmission determining result is a result of macro base station without transmission, the total number of frames T is added with 1, and the number of frames without transmission Tₘ is also added with 1. When the transmission determining result is a result of macro base station with transmission, the total number of frames T is added with 1 and the number of frames with transmission Tₙ is also added with 1.

As is clear from this, according to the method of the present embodiment, a transmission history of the macro base station is taken into account. If the macro base station without transmission case occurs relatively frequently, there is lower possibility that the macro base station without transmission case occurs again, but if the macro base station without transmission case does not occur frequently, there is higher possibility that the macro base station without transmission occurs.

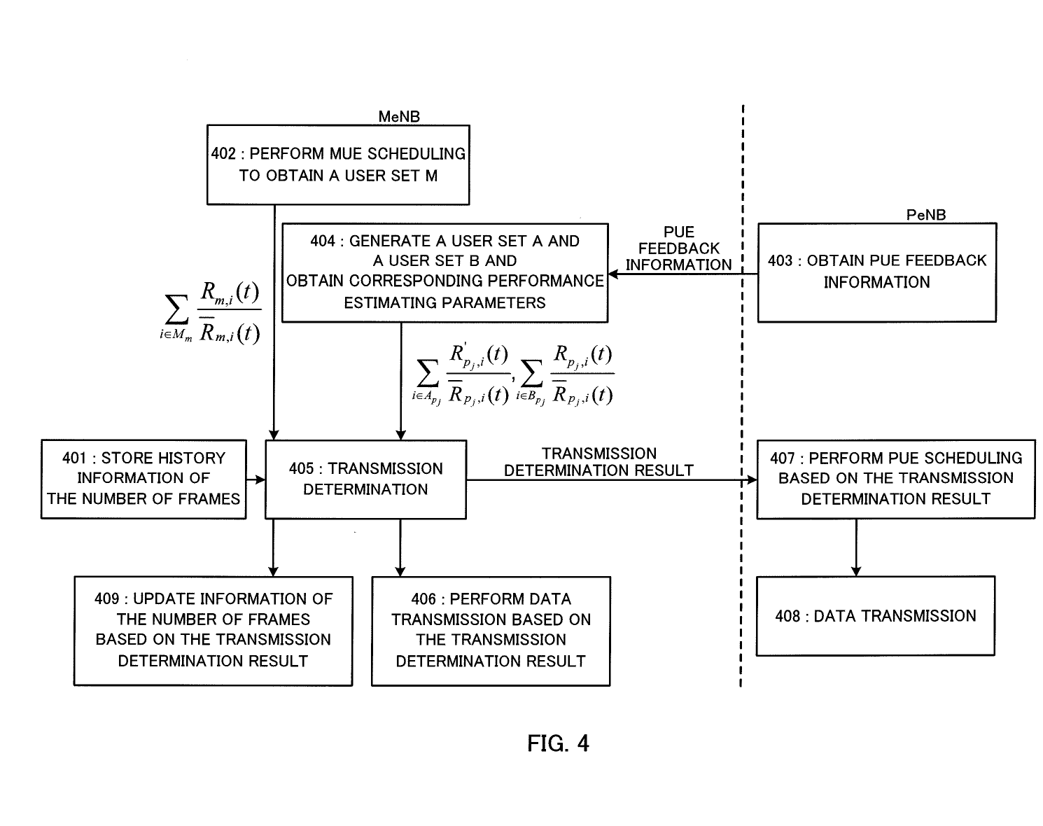

FIG. 4 illustrates a method for coordinating inter-cell interference in a heterogeneous network according to one embodiment of the present invention. This method includes the following steps.

The step 401 is similar to the step 301 in FIG. 3 and its explanation is omitted here.

In the step 402, the MUE scheduling module in the MeNB transmits the following scheduling result to the transmission determining module in the MeNB. Specifically, the scheduling result is a weighting sum of throughputs of all users scheduled by the MeNB (which is also called weighting throughput for the case of macro base station without transmission of the MeNB)

$${\sum }_{i ∈ {M}_{m}}^{ } \frac{{R}_{m , i} ( t )}{{\overline{R}}_{m , i} ( t )} .$$

In the step 404, the PUE performance estimating module of the MeNB performs performance estimation based on the feedback information of the PUE obtained from the PeNB in the step 403, and transmits at least one of the following performance estimating parameters of one or a plurality of PeNB apparatuses to the transmission determining module in the MeNB. Specifically, the performance estimating parameters are a weighting sum of throughputs of all users in the user set A (which is also called weighting throughput for the case of macro base station without transmission of the PeNB)

$${\sum }_{i ∈ {A}_{{p}_{j}}}^{ } \frac{{R}_{{p}_{j} , i}^{′} ( t )}{{\overline{R}}_{{p}_{j} , i} ( t )} ,$$

and
a weighting sum of throughputs of all users in the user set B (which is also called weighting throughput for the case of macro base station with transmission of the PeNB)

$${\sum }_{i ∈ {B}_{{p}_{j}}}^{ } \frac{{R}_{{p}_{j} , i} ( t )}{{\overline{R}}_{{p}_{j} , i} ( t )} .$$

In the step 405, the transmission determining module calculates the priorities for the two cases of MeNB mute and MeNB non-mute in accordance with the following method thereby to obtain a transmission determining result.

Specifically, the priority calculating method for the MeNB mute case is presented as follows. That is, the priority for the MeNB mute case is obtained by multiplying a weighting sum of throughputs of macro base station without transmission of all PeNB apparatuses by a difference between the total number of frames and the number of frames without transmission.

$$( {\sum }_{j = 1}^{{N}_{PeNB}} {\sum }_{i ∈ {A}_{{P}_{j}}}^{ } \frac{{R}_{{p}_{j} , i}^{′} ( t )}{{\overline{R}}_{{p}_{j} , i} ( t )} ) \cdot ( T - {T}_{m} )$$

$$or \\ ( {\sum }_{j = 1}^{{N}_{PeNB}} {\sum }_{i ∈ {A}_{{P}_{j}}}^{ } \frac{{R}_{{p}_{j} , i}^{′} ( t )}{{\overline{R}}_{{p}_{j} , i} ( t )} ) \cdot {f}_{1} ( T , {T}_{m} , {T}_{n} )$$

The priority calculating method for the MeNB non-mute case is presented as follows. That is, the priority for the MeNB non-mute case is obtained by adding up a weighting sum of throughputs for the case of macro base station with transmission for all PeNB apparatuses and a weighting throughput for the case of macro base station with transmission of the MeNB and multiplying a resultant value by a difference between the total number of frames and the number of frames with transmission.

$$( {\sum }_{i ∈ {M}_{m}}^{ } \frac{{R}_{m , i} ( t )}{{\overline{R}}_{m , i} ( t )} + {\sum }_{j = 1}^{{N}_{PeNB}} {\sum }_{i ∈ {B}_{{P}_{j}}}^{ } \frac{{R}_{{p}_{j} , i} ( t )}{{\overline{R}}_{{p}_{j} , i} ( t )} ) \cdot ( T - {T}_{n} )$$

$$or \\ ( {\sum }_{i ∈ {M}_{m}}^{ } \frac{{R}_{m , i} ( t )}{{\overline{R}}_{m , i} ( t )} + {\sum }_{j = 1}^{{N}_{PeNB}} {\sum }_{i ∈ {B}_{{P}_{j}}}^{ } \frac{{R}_{{p}_{j} , i} ( t )}{{\overline{R}}_{{p}_{j} , i} ( t )} ) \cdot {f}_{2} ( T , {T}_{m} , {T}_{n} )$$

Here, f₁(T, Tₘ, Tₙ) and f₂(T, Tₘ, Tₙ) are both functions of T, Tₘ and Tₙ.

The steps 406 to 409 are similar to the steps 306 to 309 in FIG. 3, and their explanation is omitted here.

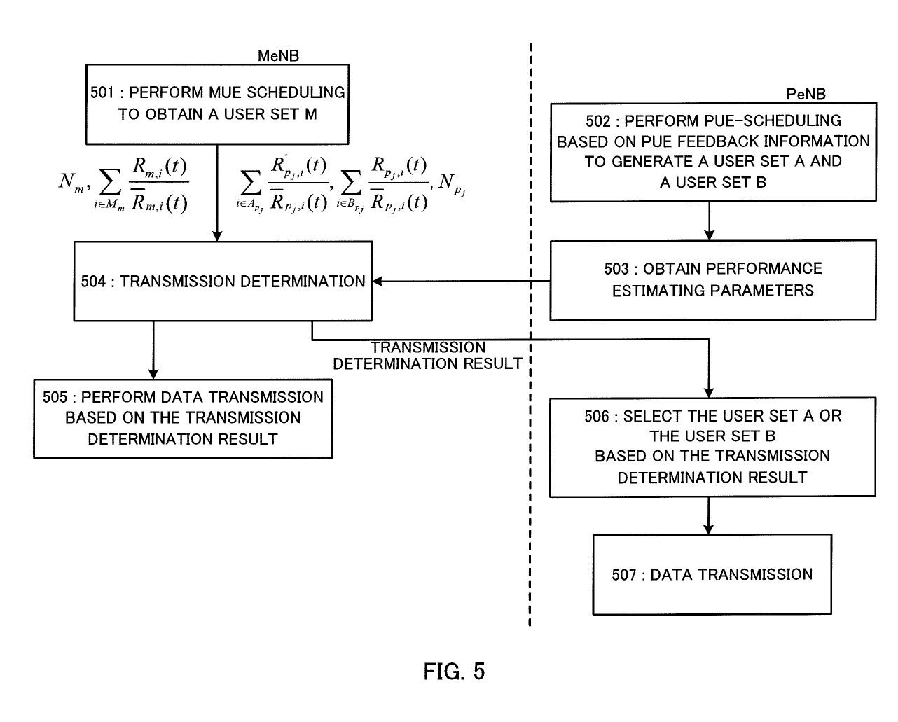

The flow of FIGS. 5 to 8 corresponds to that of FIGS. 1 to 4, respectively, and they are different in that in FIGS. 5 to 8, the PeNB provides a performance estimating parameter directly to the MeNB. Accordingly, the MeNB needs not to perform performance estimation for one or a plurality of PeNBs.

FIG. 5 illustrates a method for coordinating inter-cell interference in a heterogeneous network according to one embodiment of the present invention. This method includes the following steps.

In the step 501, the MUE scheduling module in the MeNB performs scheduling based on the feedback information of the MUE thereby to obtain a user set M, and transmits the following scheduling result to the transmission determining module in the MeNB. The scheduling result includes, specifically, at least one of a weighting sum of throughputs of all users scheduled by the MeNB (which is also called weighting throughput for the case of macro base station with transmission of the MeNB),

$${\sum }_{i ∈ {M}_{m}}^{ } \frac{{R}_{m , i} ( t )}{{\overline{R}}_{m , i} ( t )}$$

and the number of connected users Nₘ (which is also called a MUE number).

In the step 502, the PeNB performs prescheduling for each of the two cases of macro base station without transmission (MeNB mute) and macro base station with transmission (MeN non-mute) based on the feedback information of the PUE (e.g., CQI, PMI of the PUE etc.) thereby to generate a user set A and a user set B.

Specifically, the user set A is such as determined based on the feedback information of all PUE apparatuses for the MeNB mute case, the PUE apparatuses including PUE apparatuses scheduled by the PeNB for the MeNB mute case. The user set B is such as determined based on the feedback information of all PUE apparatuses for the MeNB non-mute case, the PUE apparatuses including PUE apparatuses scheduled by the PeNB for the MeNB non-mute case.

In the step 503, the PeNB apparatus sends at least one of the performance estimating parameters as feedback to the MeNB apparatus, the performance estimating parameters including, for example,

a weighting sum of throughputs of all users in the user set A (which is also called weighting throughput for the case of macro base station without transmission of the PeNB),

$${\sum }_{i ∈ {A}_{{p}_{j}}}^{ } \frac{{R}_{{p}_{j} , i}^{′} ( t )}{{\overline{R}}_{{p}_{j} , i} ( t )}$$

a weighting sum of throughputs of all users in the user set B (which is also called weighting throughput for the case of macro base station with transmission of the PeNB)

$${\sum }_{i ∈ {B}_{{p}_{j}}}^{ } \frac{{R}_{{p}_{j} , i} ( t )}{{\overline{R}}_{{p}_{j} , i} ( t )} ,$$

and

a number of connected users N_{Pj} (which is also called PUE number).

In the step 504, the transmission determining module uses feedback of one or a plurality of PeNB apparatuses within coverage of the MeNB and a scheduling result transmitted from the MUE scheduling module as a basis to compare the priorities of the two cases of MeNB mute and MeNB non-mute and obtains a transmission determination result based on the priority comparison result. For example, when the priority of the macro base station without transmission case is higher, the transmission determination result is that the MeNB does not transmit data, and otherwise, the transmission determination result is that the MeNB transmits data.

Specifically, one method for calculating the priority for the MeNB mute case is as follows:

$${\sum }_{j = 1}^{{N}_{PeNB}} {\sum }_{i ∈ {A}_{{p}_{j}}}^{ } \frac{{R}_{{p}_{j} , i}^{′} ( t )}{{\overline{R}}_{{p}_{j} , i} ( t ) \cdot {N}_{{p}_{j}}} .$$

That is, weighting throughputs for the case of macro base station without transmission fed back from all PeNB apparatuses are divided by the PUE number of a corresponding PeNB, resultant values are added up and thereby, the priority of the MeNB mute case is obtained.

One method for calculating the priority for the MeNB non-mute case is as follows:

$${\sum }_{i ∈ {M}_{m}}^{ } \frac{{R}_{m , i} ( t )}{{\overline{R}}_{m , i} ( t ) \cdot {N}_{m}} + {\sum }_{j = 1}^{{N}_{PeNB}} {\sum }_{i ∈ {B}_{{p}_{j}}}^{ } \frac{{R}_{{p}_{j} , i} ( t )}{{\overline{R}}_{{p}_{j} , i} ( t ) \cdot {N}_{{p}_{j}}}$$

that is, weighting throughputs for the case of macro base station with transmission fed back from all PeNB apparatuses are divided by the PUE number of a corresponding PeNB apparatus, resultant values are sum up, the sum is added with a value obtained by dividing a weighting throughput for the case of macro base station with transmission of the MeNB by the MUE number of the MeNB, and thereby, the priority of the MeNB non-mute case is obtained.

In the step 505, the transmission determining module transmits the transmission determination result to the transmission switch in the MeNB. By this transmission, the data transmission of the MeNB is controlled appropriately. When the transmission determination result is a result of the MeNB without transmission case, the transmission switch switches off the data transmission of the MeNB and when the transmission determination result is a result of the MeNB with transmission, the transmission switch switches on the data transmission of the MeNB.

In the steps 506 to 507, the transmission determination module sends the transmission determination result as feedback to one or a plurality of PeNB apparatuses and the PeNB performs data transmission based on the received result.

Specifically, when the transmission determination result is a result of the MeNB without transmission, the PeNB performs user scheduling based on the user set A and transmits data. When the transmission determination result is a result of MeNB with transmission, the PeNB performs data transmission based on the user set B. As a difference from the step 106, in the step 506, the PeNB does not need to perform PUE scheduling, but determines a suitable user set directly from the user set A and the user set B thereby to perform data transmission.

As is clear from this, according the method of the present embodiment, the different numbers of connected users at respective transmission points and different SINR (Signal to Interference plus Noise Ratio) of connected users are considered. When performing transmission determination of the macro base station, the priority after proportional fair scheduling of each transmission point is divided by the number of connected users of the corresponding transmission point (or the function of the number of connected users), and thereby the transmission determination becomes more fair. That is, by adopting the method of the present embodiment, it is possible to solve such a problem that the rate of the macro base station without transmission is higher or lower due to a difference in the number of connected users and/or difference in SINR.

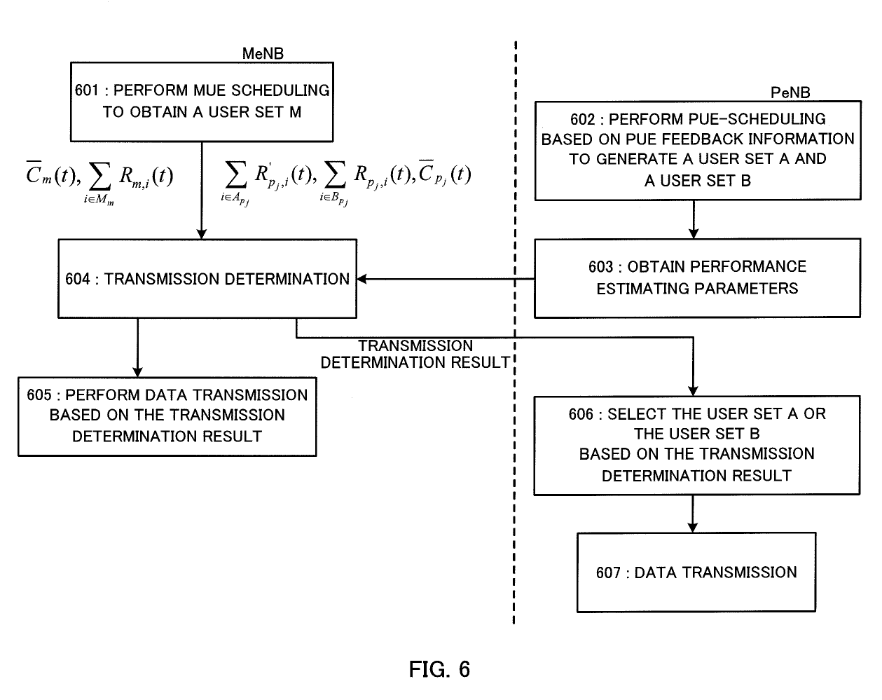

FIG. 6 is a method for coordinating inter-cell interference in a heterogeneous network according to one embodiment of the present invention. The method includes the following steps.

The steps 601 to 604 correspond to the steps 501 to 504 in FIG. 5.

As a matter to be explained, in the step 601, the MUE scheduling module in the MeNB performs scheduling based on the feedback information of the macro base station user and after that, it transmits the following scheduling results to the transmission determining module in the MeNB. The scheduling results are, that is, a sum of throughputs of all users scheduled by the MeNB (which is also called throughput for the case of macro base station with transmission of the MeNB)

$${\sum }_{i ∈ {M}_{m}}^{ } {R}_{m , i} ( t ) ,$$

an average throughput at the past time of the MeNB C̅ₘ. In the step 603, the PeNB transmits at least one of the following performance estimating parameters as feedback to the MeNB. Specifically, the performance estimating parameters are a sum of throughputs of all users in the user set A (which is also called throughput for the case of macro base station without transmission of the PeNB)

$${\sum }_{i ∈ {A}_{{P}_{j}}}^{ } {R}_{{p}_{j} , i}^{′} ( t )$$

a sum of throughputs of all users in the user set B (which is also called throughput for the case of macro base station with transmission of the PeNB)

$${\sum }_{i ∈ {B}_{{P}_{j}}}^{ } {R}_{{p}_{j} , i} ( t ) ,$$

an average throughput at the past time of the PeNB C̅ₚ_{ⱼ}.
In the step 640, the transmission determining module calculates the priority for the MeNB mute case and the priority for the MeNB non-mute case in accordance with the following method, thereby to obtain a transmission determination result.

Specifically, the method for calculating the priority for the MeNB mute case is presented below. That is, throughputs for macro base station without transmission fed back from all PeNB apparatuses are divided by an average throughput of a corresponding PeNB and resultant values are summed up thereby to obtain priority for the MeNB mute case.

$${\sum }_{j = 1}^{{N}_{PeNB}} {\sum }_{i ∈ {A}_{{p}_{j}}} \frac{{R}_{{p}_{j} , i}^{′} ( t )}{{\overline{C}}_{{p}_{j}} ( t )}$$

The method for calculating a priority for the MeNB non-mute case is presented below. That is, throughputs for the case of macro base station with transmission fed back from all PeNB apparatuses are divided by an average throughput of a suitable PeNB apparatus and resultant values are summed up. Then, the sum is added with a value obtained by dividing a throughput for macro base station with transmission of the MeNB apparatus by an average throughput of the MeNB thereby to obtain a priority for MeNB non-mute case.

$${\sum }_{i ∈ {M}_{m}} \frac{{R}_{m , i} ( t )}{{\overline{C}}_{m} ( t )} + {\sum }_{j = 1}^{{N}_{PeNB}} {\sum }_{i ∈ {A}_{pj}} \frac{{R}_{{p}_{j} , i}^{′} ( t )}{{\overline{C}}_{{p}_{j}} ( t )}$$

The steps 605 to 607 are the same as the steps 505 to 507 in FIG. 5 and its explanation is omitted here.

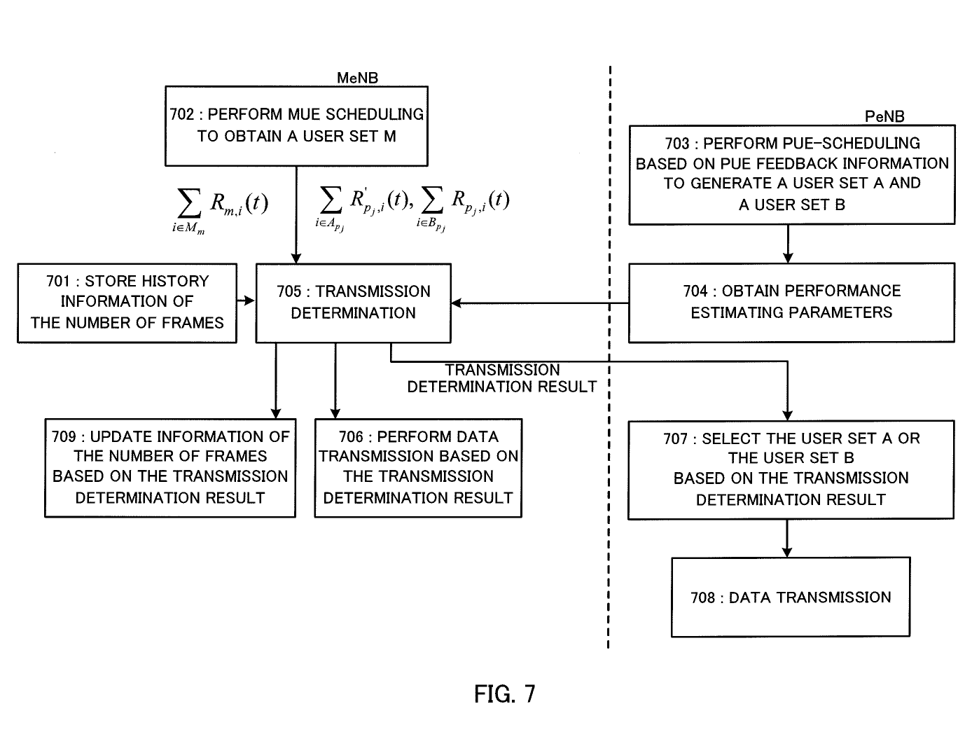

FIG. 7 illustrates a method for coordinating inter-cell interference in a heterogeneous network according to one embodiment of the present invention. The method includes the following steps.

In the step 701, a transmission storing module in the MeNB apparatus transmits at least one of the following frame number information pieces to the transmission determining module in the MeNB. The frame number information pieces include the total number of frames T, the number of frames with transmission Tₙ, and the number of frames without transmission Tₘ. The steps 702 to 705 correspond to the steps 501 to 504 in FIG. 5, respectively.

As a matter to be explained, in the step 702, the MUE scheduling module in the MeNB apparatus transmits the following scheduling results to the transmission determining module in the MeNB, the scheduling results including a sum of throughputs of all users scheduled by the MeNB apparatus (which is also called throughput for the case of macro base station with transmission of the MeNB)

$${\sum }_{i ∈ {M}_{m}} {R}_{m , i} ( t ) .$$

In the step 704, the PeNB apparatus transmits at least one of the following performance estimating parameters as feedback to the MeNB, the performance estimating parameters including a sum of throughputs of all users in the user set A (which is also called throughput for the case of macro base station without transmission of the PeNB)

$${\sum }_{i ∈ {A}_{{P}_{j}}} {R}_{{p}_{j} , i}^{′} ( t ) ,$$

a sum of throughputs of all users in the user set B (which is also called throughput for macro base station with transmission of the PeNB)

$${\sum }_{i ∈ {B}_{{P}_{j}}} {R}_{{p}_{j} , i} ( t ) .$$

In the step 705, the transmission determining module calculates a priority for the MeNB mute case and a priority for the MeNB non-mute case in accordance with the following method thereby to obtain a transmission determination result.

Specifically, the method for calculating a priority for the MeNB mute case is explained below. That is, throughputs for macro base station without transmission fed back from all PeNB apparatuses are summed up, the resulting sum is multiplied by a difference between the total number of frames and the number of frames without transmission, thereby to obtain a priority for the MeNB mute case.

$$( {\sum }_{j = 1}^{{N}_{PeNB}} {\sum }_{i ∈ {A}_{{P}_{j}}} {R}_{{p}_{j} , i}^{′} ( t ) ) \cdot ( T - {T}_{m} )$$

The method for calculating a priority for the MeNB non-mute case is explained below. That is, a sum of throughputs for macro base station with transmission fed back from all PeNB apparatuses and a throughput for macro base station with transmission of the MeNB are summed up, the resulting sum is multiplied by a difference between the total number of frames and the number of frames with transmission, thereby to obtain a priority for the MeNB non-mute case.

$$( {\sum }_{i ∈ {M}_{m}} {R}_{m , i} ( t ) + {\sum }_{j = 1}^{{N}_{PeNB}} {\sum }_{i ∈ {B}_{{P}_{j}}} {R}_{{p}_{j} , i} ( t ) ) \cdot ( T - {T}_{n} )$$

The steps 706 to 708 are the same as the steps 505 to 507 in FIG. 5, and their explanation is omitted here.

In the step 709, the transmission determining module provides a transmission determination result to the transmission storing module of the MeNB, and the transmission storing module updates the frame number information.

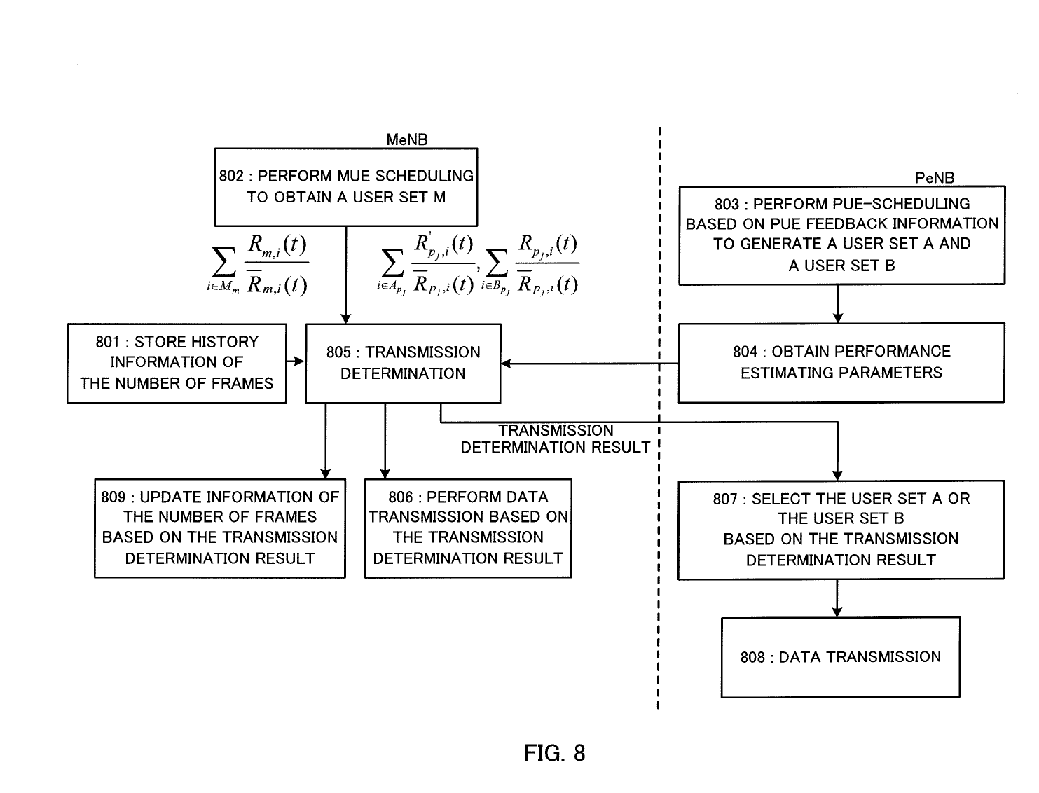

FIG. 8 illustrates the method for coordinating inter-cell interference in a heterogeneous network in one embodiment of the present invention. The method includes the following steps.

The step 801 is the same as the step 701 in FIG. 7 and its explanation is omitted here.

The steps 802 to 805 correspond to the steps 501 to 504 in FIG. 5, respectively.

As a matter to be explained, in the step 802, the MUE scheduling module in the MeNB transmits the following scheduling results to the transmission determining module in the MeNB, the scheduling results including a weighting sum of throughputs of all users scheduled by the MeNB (which is also called weighting throughput for the case of macro base station with transmission of the MeNB)

$${\sum }_{i ∈ {M}_{m}} \frac{{R}_{m , i} ( t )}{{\overline{C}}_{m} ( t )} .$$

In the step 804, the PeNB transmits at least one of the following performance estimating parameters as feedback to the MeNB, the performance estimating parameters including a weighting sum of throughputs of all users in the user set A (which is also called weighting throughput for macro base station without transmission of the PeNB)

$${\sum }_{i ∈ {A}_{pj}} \frac{{R}_{{p}_{j} , i}^{′} ( t )}{{\overline{C}}_{{p}_{j}} ( t )} ,$$

a weighting sum of throughputs of all users in the user set B (which is also called weighting throughput for macro base station with transmission of the PeNB)

$${\sum }_{i ∈ {B}_{{p}_{j}}} \frac{{R}_{{p}_{j} , i} ( t )}{{\overline{R}}_{{p}_{j} , i} ( t )} .$$

In the step 805, the transmission determining module calculates a priority for the MeNB mute case and a priority for the MeNB non-mute case in accordance with the following methods thereby to obtain a transmission determination result.

Specifically, one method for calculating a priority for the MeNB mute case is explained below. That is, weighting throughputs for macro base station without transmission fed back from all PeNB apparatuses are summed up, the resulting sum is multiplied by a difference between the total number of frames and the number of frames without transmission thereby to obtain a priority for the MeNB mute case.

$$( {\sum }_{j = 1}^{{N}_{PeNB}} {\sum }_{i ∈ {A}_{{P}_{j}}} \frac{{R}_{{p}_{j} , i}^{′} ( t )}{{\overline{R}}_{{p}_{j} , i} ( t )} ) \cdot ( T - {T}_{m} )$$

One method for calculating a priority for the MeNB non-mute case is explained below. That is, a weighting sum of throughputs for macro base station with transmission fed back from all PeNB apparatuses and a weighting throughput for macro base station with transmission of the MeNB apparatus are summed up, and the resulting sum is multiplied by a difference between the total number of frames and the number of frames with transmission thereby to calculate a priority for the MeNB non-mute case.

$$( {\sum }_{i ∈ {M}_{m}} \frac{{R}_{m , i} ( t )}{{\overline{R}}_{m , i} ( t )} + {\sum }_{j = 1}^{{N}_{PeNB}} {\sum }_{i ∈ {B}_{{P}_{j}}} \frac{{R}_{{p}_{j} , i} ( t )}{{\overline{R}}_{{p}_{j} , i} ( t )} ) \cdot ( T - {T}_{n} )$$

The steps 806 to 809 are the same as the steps 706 to 709 in FIG. 7 and their explanation is omitted here.

In another specific embodiment of the present invention, the normal base station can determine a priority for normal base station without transmission by using the equation:

$${\sum }_{j = 1}^{{N}_{PeNB}} {\sum }_{i ∈ {A}_{{P}_{j}}} \frac{{R}_{{p}_{j} , i}^{′} ( t )}{{\overline{R}}_{{p}_{j} , i} ( t )}$$

$$or$$

$${\sum }_{j = 1}^{{N}_{PeNB}} {\sum }_{i ∈ {A}_{{P}_{j}}} \frac{{R}_{{p}_{j} , i}^{′} ( t )}{f ( {W}_{{p}_{j} , i} ( t ) )} ,$$

and it can determine a priority for normal base station with transmission by using the equation:

$${\sum }_{i ∈ {M}_{m}} \frac{{R}_{m , i} ( t )}{{W}_{m , i} ( t )} + {\sum }_{j = 1}^{{N}_{PeNB}} {\sum }_{i ∈ {B}_{{P}_{j}}} \frac{{R}_{{p}_{j} , i} ( t )}{{W}_{{p}_{j} , i} ( t )}$$

$$or$$

$${\sum }_{i ∈ {M}_{m}} \frac{{R}_{m , i} ( t )}{f ( {W}_{m , i} ( t ) )} + {\sum }_{j = 1}^{{N}_{PeNB}} {\sum }_{i ∈ {B}_{{P}_{j}}} \frac{{R}_{{p}_{j} , i} ( t )}{f ( {W}_{{p}_{j} , i} ( t ) )} .$$

Here, W_{Pj,i}(t) is a total amount of data to transmit to the i-th user in a corresponding user set of the j-th low-power base station, f(W_{Pj,i}(t)) is a function of W_{Pj,i}(t), W_{m,i}(t) is a total amount of data to transmit to the i-th user in a corresponding user set of the normal base station, and f(W_{m,i}(t)) is a function of W_{m,i}(t). In this case, comparing with the flow illustrated in FIG. 1 or 5, the normal base station needs to obtain additional parameters such as W_{Pj,i}(t) and W_{m,i}(t).

Needless to say, the normal base station can determine a priority for normal base station without transmission by using the equation:

$${\sum }_{j = 1}^{{N}_{PeNB}} {\sum }_{i ∈ {A}_{{P}_{j}}} ( {R}_{{p}_{j} , i}^{′} ( t ) \cdot {S}_{{p}_{j} , i} ( t ) )$$

$$or$$

$${\sum }_{j = 1}^{{N}_{PeNB}} {\sum }_{i ∈ {A}_{{P}_{j}}} ( {R}_{{p}_{j} , i}^{′} ( t ) \cdot f ( {S}_{{p}_{j} , i} ( t ) ) ) ,$$

and it can determine a priority for normal base station with transmission by using the equation:

$${\sum }_{i ∈ {M}_{m}} ( {R}_{m , i} ( t ) \cdot {S}_{m , i} ( t ) ) + {\sum }_{j = 1}^{{N}_{PeNB}} {\sum }_{i ∈ {B}_{{P}_{j}}} ( {R}_{{p}_{j} , i} ( t ) \cdot {S}_{{p}_{j} , i} ( t ) )$$

$$or$$

$${\sum }_{i ∈ {M}_{m}} ( {R}_{m , i} ( t ) \cdot f ( {S}_{m , i} ( t ) ) ) + {\sum }_{j = 1}^{{N}_{PeNB}} {\sum }_{i ∈ {B}_{{P}_{j}}} ( {R}_{{p}_{j} , i} ( t ) \cdot f ( {S}_{{p}_{j} , i} ( t ) ) ) .$$

Here, S_{Pj,i}(t) is a total amount of data to transmit to the i-th user in a corresponding user set of the j-th low-power base station, f(S_{Pj,i}(t)) is a function of S_{Pj,i}(t), S_{m,i}(t) is a total amount of data to transmit to the i-th user in a corresponding user set of the normal base station and f(S_{m,i}(t)) is a function of S_{m,i}(t). In this case, comparing with the flow illustrated in FIG. 1 or 5, the normal base station needs to obtain additional parameters such as S_{Pj,i}(t) and S_{m,i}(t).

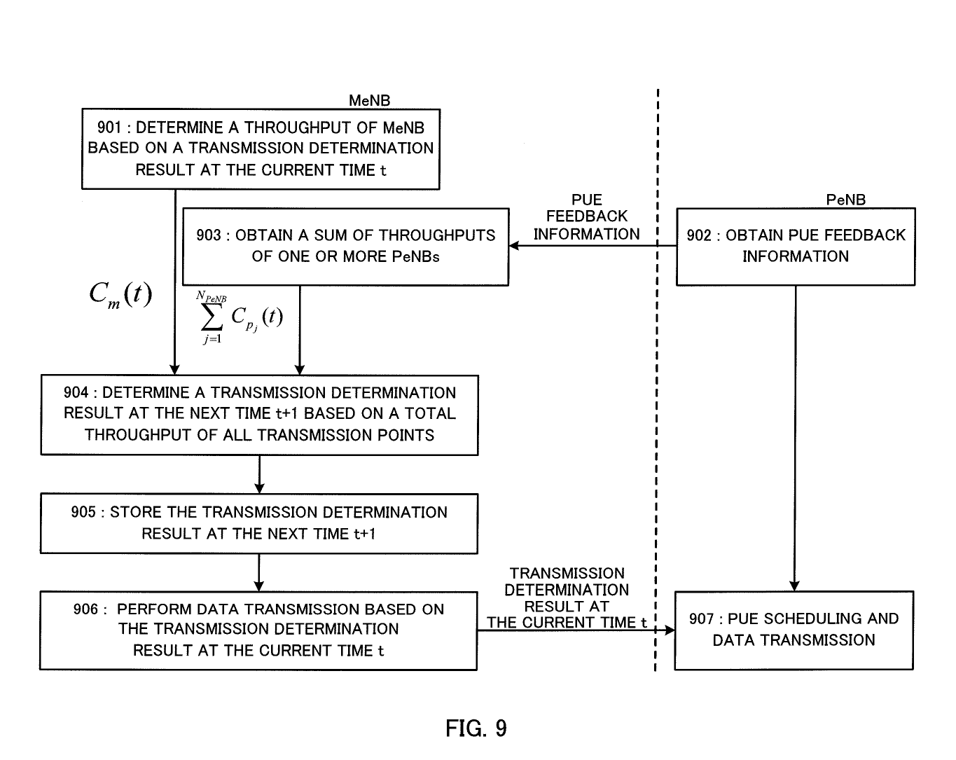

FIG. 9 illustrates the method for coordinating inter-cell interference in a heterogeneous network according to one embodiment of the present invention. The method includes the following steps.

In the step 901, the MUE scheduling module in the MeNB apparatus uses a transmission determination result d(t) at the current time t obtained from the determination storing module as a basis to determine a throughput Cₘ(t) at the current time t of the MeNB, and provides it to each of the transmission determining module and the throughput storing module of the MeNB apparatus.

Specifically, if the transmission determination result at the current time t is a result for MeNB without transmission, the MeNB apparatus sets the throughput Cₘ(t) at the current time t to 0. If the transmission determination result at the current time t is a result for MeNB with transmission, the MeNB apparatus performs MeNB user scheduling and obtains a throughput Cₘ(t) at the current time t.

In the step 902, one or a plurality of PeNB apparatuses provide PUE feedback information to the MeNB apparatus.

In the step 903, the PUE performance estimating module in the MeNB apparatus uses the transmission determination result at the current time t obtained from the determination storing module as a basis to obtain a sum of throughputs at the current time t of the one or plurality of PeNB apparatuses

$${\sum }_{j = 1}^{{N}_{PeNB}} {C}_{{p}_{j}} ( t ) ,$$

and provides it to each of the transmission determining module and the throughput storing module in the MeNB apparatus.

Specifically, if the transmission determination result at the current time t is a result for MeNB without transmission, the MeNB apparatus performs PeNB user scheduling in accordance with the MeNB without transmission case and obtains a sum of throughputs at the current time t of the one or plurality of PeNB apparatuses.

$${\sum }_{j = 1}^{{N}_{PeNB}} {C}_{{p}_{j}} ( t )$$

If the transmission determination result at the current time t is a result for MeNB with transmission, the MeNB performs PeNB user scheduling in accordance with the MeNB with transmission case and obtains a sum of throughputs at the current time t of the one or plurality of PeNB apparatuses.

$${\sum }_{j = 1}^{{N}_{PeNB}} {C}_{{p}_{j}} ( t )$$

In the step 904, the transmission determining module in the MeNB apparatus determines a transmission determination result d(t+1) at the next time t+1 by using the equation:

$${C}_{m} ( t ) + {\sum }_{j = 1}^{{N}_{PeNB}} {C}_{{p}_{j}} ( t ) .$$

Specifically, the transmission determining module in the MeNB apparatus g a total throughput at the current time t:

$${C}_{m} ( t ) + {\sum }_{j = 1}^{{N}_{PeNB}} {C}_{{p}_{j}} ( t )$$

with a total throughput at the previous time t−1 obtained from the throughput storing module:

$${C}_{m} ( t - 1 ) + {\sum }_{j = 1}^{{N}_{PeNB}} {C}_{{p}_{j}} ( t - 1 ) .$$

where

$${C}_{m} ( t ) + {\sum }_{j = 1}^{{N}_{PeNB}} {C}_{{p}_{j}} ( t )$$

is greater than

$${C}_{m} ( t - 1 ) + {\sum }_{j = 1}^{{N}_{PeNB}} {C}_{{p}_{j}} ( t - 1 )$$

The transmission determining module in the MeNB apparatus sets a transmission determining result at the next time t+1 to be the same as the transmission determination result at the current time t obtained from the determination storing module.
where

$${C}_{m} ( t ) + {\sum }_{j = 1}^{{N}_{PeNB}} {C}_{{p}_{j}} ( t )$$

is not greater than

$${C}_{m} ( t - 1 ) + {\sum }_{j = 1}^{{N}_{PeNB}} {C}_{{p}_{j}} ( t - 1 )$$

The MeNB apparatus sets the transmission determination result at the next time t+1 to be opposite to the transmission determination result at the current time t obtained from the determination storing module. That is, when the transmission determination result at the current time t is a result for MeNB with transmission, the transmission determination result at the next time t+1 is opposite to the transmission determination result at the current time t and that is, it becomes a result for MeNB without transmission. When the transmission determination result at the current time t is a result for MeNB without transmission, the transmission determination result at the next time t+1 is set to be a result for MeNB with transmission.

In the step 905, the transmission determining module stores the transmission determination result at the next time t+1 determined in the step 904, in the determination storing module of the MeNB apparatus. With this storing, it is possible to execute the operation in accordance with MeNB without transmission or MeNB with transmission at the next time t+1.

In the step 906, the determination storing module in the MeNB apparatus transmits a transmission determination result at the current time t to the transmission switch in the MeNB apparatus. With this transmission, it is possible to make appropriate control of data transmission of the MeNB apparatus.

In the step 907, the determination storing module feeds the transmission determination result at the current time t back to one or a plurality of PeNB apparatuses, and each PeNB performs PUE scheduling based on the received result and executes appropriate data transmission.

As a matter to be explained, the steps in the flow illustrated in FIG. 9 need not to be executed following the order. For example, the step 901 may be executed simultaneously with the step 907.

In another embodiment of the present invention, the steps 902 and 903 need not to be executed. Accordingly, after the determination storing module feeds a transmission determination result at the current time t back to PeNB apparatuses, if the transmission determination result at the current time t is a result for MeNB without transmission, each PeNB performs PeNB user scheduling in accordance with MeNB without transmission, obtains a throughput C_{Pj}(t) at the current time t of its own station and transmits it to the transmission determining module of the MeNB apparatus. When the transmission determination result at the current time t is a result for MeNB with transmission, each PeNB performs PeNB user scheduling in accordance with MeNB with transmission, obtains a throughput C_{Pj}(t) at the current time t of its own station and transmits it to the transmission determining module of the MeNB apparatus.

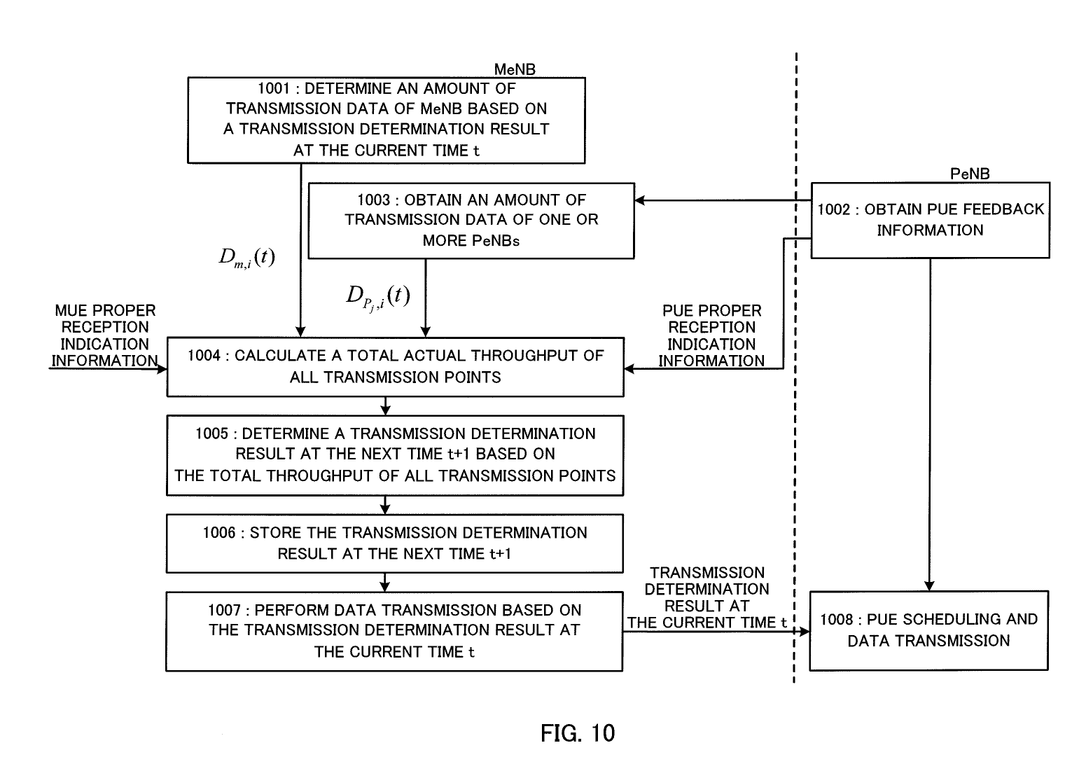

FIG. 10 illustrates a method for coordinating inter-cell interference in a heterogeneous network according to one embodiment of the present invention. The method includes the following steps.

In the step 1001, the MUE scheduling module in the MeNB apparatus uses the transmission determination result d(t) at the current time t obtained from the determination storing module as a basis to determine an amount of transmission data D_{m,i}(t) of the MeNB apparatus.

In the step 1002, one or a plurality of PeNB apparatuses provide PUE feedback information to the MeNB apparatus. Specifically, each PeNB apparatus provides CQI, PMI and the like to the PUE performance estimating module in the MeNB apparatus, and provides PUE proper reception indication information ACK/NACK to the actual throughput calculating module in the MeNB apparatus. Here, the ACK indicates that a PUE apparatus has successfully received data transmitted from the PeNB apparatus, and the NACK indicates that a PUE apparatus has not successfully received the data transmitted from the PeNB apparatus.

In the step 1003, the PUE performance estimating module determines an amount of transmission data D_{Pj,i}(t) of one or a plurality of PeNB apparatuses based on obtained PUE feedback information.

In the step 1004, the actual throughput calculating module in the MeNB determines a total actual throughput at each of the time t−τ and the time t−τ−1 for each of all transmission points.

In the step 1005, the transmission determining module uses the following scheme at the present time t and determines a transmission determination result d(t+1) at the next time t+1.

Specifically, the transmission determining module in the MeNB compares the actual throughput at the time t−τ

$${\sum }_{i} ( {D}_{m , i} ( t - τ ) \cdot {AN}_{m , i} ( t - τ ) ) + {\sum }_{j = 1}^{{N}_{PeNB}} {\sum }_{i} ( {D}_{{P}_{j} , i} ( t - τ ) \cdot {AN}_{{P}_{j} , i} ( t - τ ) )$$

with the actual throughput at the time t−τ−1

$${\sum }_{i} ( {D}_{m , i} ( t - τ - 1 ) \cdot {AN}_{m , i} ( t - τ - 1 ) ) + {\sum }_{j = 1}^{{N}_{PeNB}} {\sum }_{i} ( {D}_{{P}_{j} , i} ( t - τ - 1 ) \cdot {AN}_{{P}_{j} , i} ( t - τ - 1 ) ) .$$

When the actual throughput at the time t−τ is greater than the actual throughput at the time t−τ−1, the equation d(t+1)=d(t) is satisfied. When the actual throughput at the time t−τ is not greater than the actual throughput at the time t−τ−1, d(t+1) is set to be different from d(t).

Here, τ is a feedback time delay of proper reception indication information, D_{m,i}(t−τ) is the amount of transmission data at the time t−τ for the i-th user in the corresponding user set of the MeNB, and D_{Pj,i}(t−τ) is the amount of transmission data at the time t−τ for the i-th user in the corresponding user set of the j-th PeNB. AN_{m,i}(t−τ) is proper reception indication information at the time t−τ of the i-th user in the corresponding user set of the MeNB, AN_{Pj,i}(t−τ) is proper reception indication information at the time t−τ of the i-th user in the corresponding user set of the j-th PeNB, and both of the values are either 0 or 1. Specifically, when ACK is received, a value of AN_{m,i}(t−τ) and AN_{Pj,i}(t−τ) is 1, and when NACK is received, a value of AN_{m,i}(t−τ) and AN_{Pj,i}(t−τ) is 0.

The steps 1006 to 1008 are the same as the steps 905 to 907 in FIG. 9, and their explanation is omitted here.

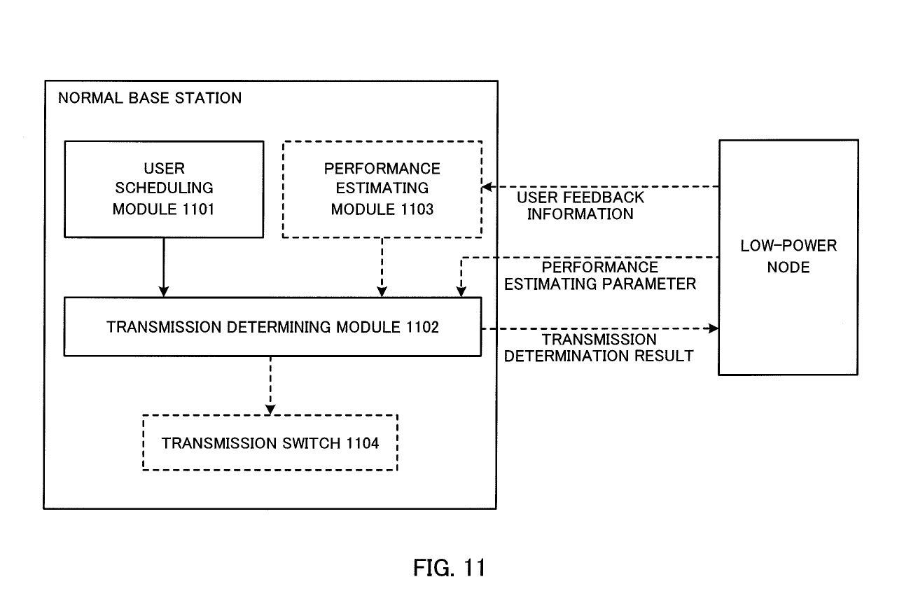

An embodiment of the present invention provides a normal base station. As illustrated in FIG. 11, the normal base station comprises a user scheduling module 1101 configured to perform scheduling based on feedback information of users of the normal base station and obtain a user scheduling result of the normal base station, and a transmission determining module 1102 configured to obtain a performance estimating parameter for normal base station without transmission and a performance estimating parameter for normal base station with transmission of one or a plurality of low-power base stations, use the performance estimating parameters and the user scheduling result of the normal base station as a basis to determine a priority for normal base station without transmission and a priority for normal base station with transmission as to actual transmission characteristics of different transmission points, and compares these priorities thereby to obtain a transmission determination result.

In an illustrative embodiment of the present invention, the transmission determining module 1102 can determines the priority in accordance with the equations and steps illustrated in FIGS. 1 to 8, and its explanation is omitted here.

Further, the normal base station comprises a performance estimating module 1103 configured to receive feedback information of users from one or a plurality of low-power base station users, perform user scheduling of the low-power base stations for normal base station without transmission to obtain a first user set A_{Pj}, perform user scheduling of the low-power base stations for normal base station with transmission to obtain a second user set B_{Pj}, perform performance estimation for each of the first user set A_{Pj} and the second user set B_{Pj} and obtain corresponding performance estimating parameters.

both of the

Needless to say, in another specific embodiment of the present invention, the performance estimating parameters may be fed back directly to the transmission determining module 1102 of the normal base station from the low-power base station. Its specific flow can be seen with reference to FIGS. 5 to 8 and its explanation is omitted here.

Further, the normal base station includes a transmission switch 1104 configured to switch on and off data transmission of the normal base station.

An embodiment of the present invention also provides a heterogeneous network. The heterogeneous network includes a normal base station configured to perform scheduling based on feedback information of users of the normal base station, obtain a user scheduling result of the normal base station, obtains performance estimating parameters for both of normal base station with transmission and normal base station without transmission of one or a plurality of low-power base stations within coverage of the normal base station, use the user scheduling result of the normal base station and the performance estimating parameters as a basis to determine a priority for normal base station without transmission and a priority for normal base station with transmission as to actual transmission characteristics of different transmission points, compares the priorities to obtain a transmission determination result and perform data transmission based on the transmission determination result, and the one or plurality of low-power base stations configured to perform pre-scheduling based on the feedback information of users of own stations, obtain a first user set for normal base station without transmission and a second user set Bₚⱼ for normal base station with transmission, perform performance estimation for each of the first user set Aₚⱼ and the second user set and send the obtained performance estimating parameters as feedback to the normal base station.

In an illustrative embodiment of the present invention, the normal base station may determine the priorities following the equations and steps illustrated in the flows of FIGS. 1 to 8, which explanation is omitted here.

Specifically, the normal base station further sends the transmission determination result as feedback to the one or plurality of low-power base stations. Each of the low-power base stations further determines an appropriate user set out of the first user set Aₚⱼ and the second user set B_{Pj} based on the transmission determination result and performs data transmission.

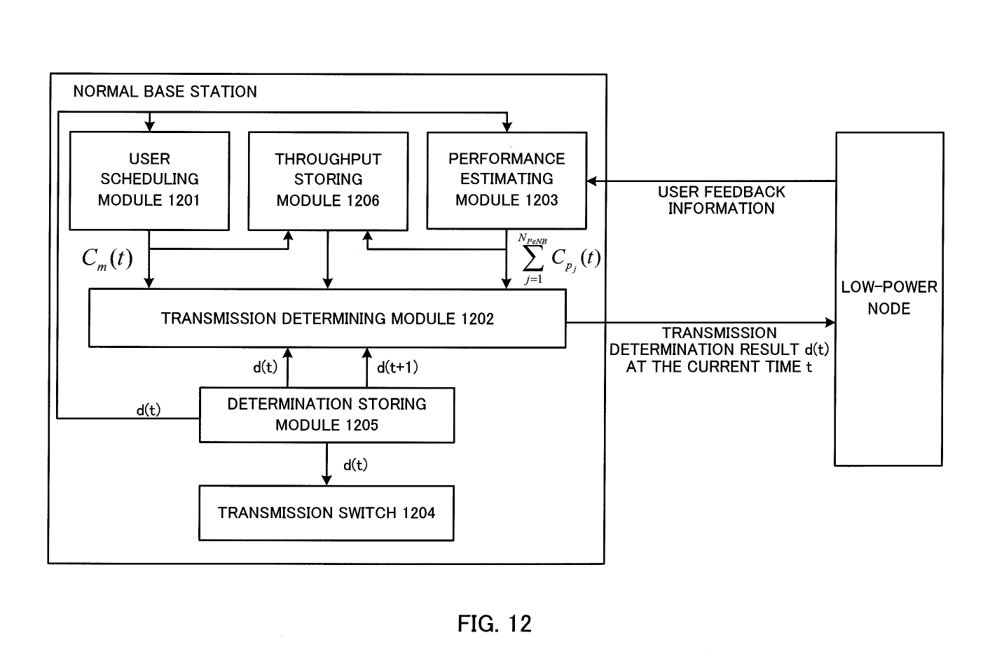

The present invention also provides another normal base station. As illustrated in FIG. 12, the normal base station comprises a user scheduling module 1201 configured to determine an estimated throughput Cₘ(t) at the current time t of the normal base station based on the transmission determination result at the current time t, and a transmission determining module 1202 configured to calculate

$${C}_{m} ( t ) + {\sum }_{j = 1}^{{N}_{PeNB}} {C}_{{p}_{j}} ( t )$$

which is a sum of the estimated throughput Cₘ(t) of the normal base station and a sum of estimated throughputs at the current time t of the one or plurality of low-power base stations

$${\sum }_{j = 1}^{N - PeNB} {C}_{{p}_{j}} ( t ) ,$$

also obtain a sum of estimated throughputs at the previous time t−1

$${C}_{m} ( t - 1 ) + {\sum }_{j = 1}^{{N}_{PeNB}} {C}_{{p}_{j}} ( t - 1 ) ,$$

and determine a transmission determination result at the next time t+1 thereby to be able to execute the operation in accordance with the normal base station without transmission or normal base station with transmission at the next time t+1 based on the transmission determination result.

In a specific embodiment of the present invention, the normal base station further comprises a performance estimating module 1203 configured to, when the transmission determination result at the current time t is a result for normal base station without transmission, perform user scheduling of the low-power base stations in accordance with the normal base station without transmission and obtain a sum of estimated throughputs at the current time t of the one or plurality of low-power base stations:

$${\sum }_{j = 1}^{{N}_{PeNB}} {C}_{{p}_{j}} ( t ) .$$

and to, when the transmission determination result at the current time t is a result for normal base station with transmission, perform user scheduling of the low-power base stations in accordance with the normal base station with transmission and obtain a sum of estimated throughputs at the current time t of the one or plurality of low-power base stations:

$${\sum }_{j = 1}^{{N}_{PeNB}} {C}_{{p}_{j}} ( t )$$

In a specific embodiment of the present invention, the normal base station further comprises a transmission switch 1204 configured to switch on or off data transmission of the normal base station based on the transmission determination result at the current time t.

In a specific embodiment of the present invention, the normal base station further comprises a determination storing module 1205 configured to store the transmission determination result at each time and provide the transmission determination result at the current time t to the transmission determining module 1202. Further, the determination storing module 1205 further provides the transmission determination result at the current time t to the user scheduling module 1201 and the performance estimating module 1203.

The transmission determining module 1202 compares a total estimated throughput at the current time t:

$${C}_{m} ( t ) + {\sum }_{j = 1}^{{N}_{PeNB}} {C}_{{p}_{j}} ( t )$$

with a total estimated throughput at the previous time t−1:

$${C}_{m} ( t - 1 ) + {\sum }_{j = 1}^{{N}_{PeNB}} {C}_{{p}_{j}} ( t - 1 ) ,$$

when

$${C}_{m} ( t ) + {\sum }_{j = 1}^{{N}_{PeNB}} {C}_{{p}_{j}} ( t )$$

is greater than

$${C}_{m} ( t - 1 ) + {\sum }_{j = 1}^{{N}_{PeNB}} {C}_{{p}_{j}} ( t - 1 ) ,$$

the normal base station sets the transmission determination result at the next time t+1 to be the same as the transmission determination result at the current time t
when

$${C}_{m} ( t ) + {\sum }_{j = 1}^{{N}_{PeNB}} {C}_{{p}_{j}} ( t )$$

is not greater than

$${C}_{m} ( t - 1 ) + {\sum }_{j = 1}^{{N}_{PeNB}} {C}_{{p}_{j}} ( t - 1 )$$

and the normal base station sets the transmission determination result at the next time t+1 to be opposite to the transmission determination result at the current time t.

In another specific embodiment of the present invention, the normal base station further comprises a throughput storing module 1206 configured to store Cₘ(t) obtained from the user scheduling module 1201 and the following value provided from the performance estimating module 1203:

$${\sum }_{j = 1}^{{N}_{PeNB}} {C}_{{p}_{j}} ( t )$$

and to provide a sum of estimated throughputs at the previous time t−1:

$${C}_{m} ( t - 1 ) + {\sum }_{j = 1}^{{N}_{PeNB}} {C}_{{p}_{j}} ( t - 1 )$$

to the transmission determining module 1202.

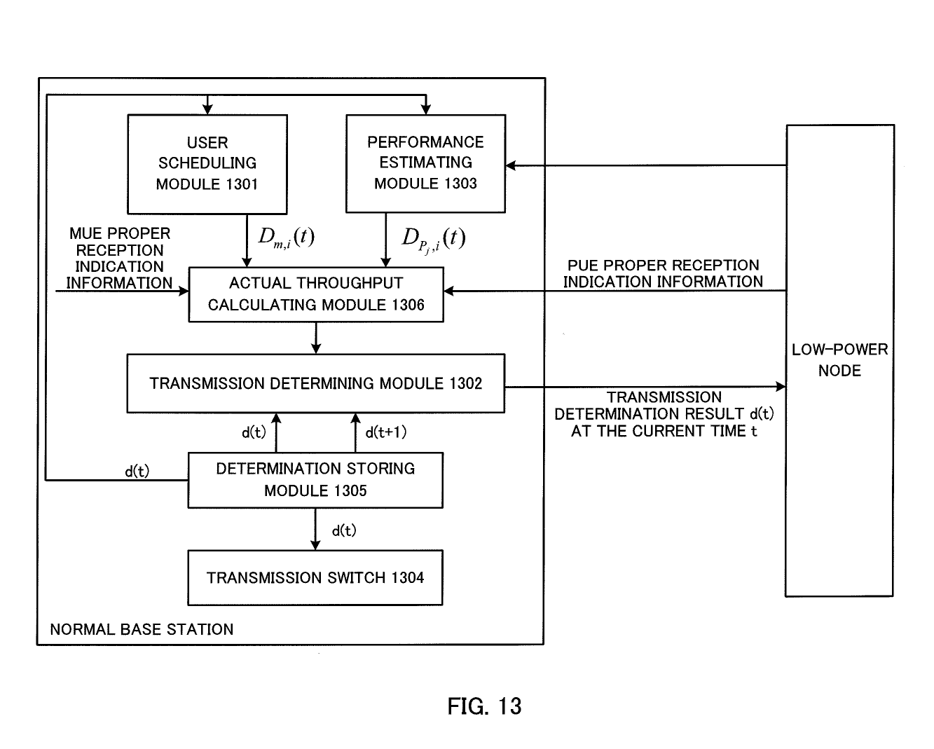

The present invention provides another normal base station. As illustrated in FIG. 13, the normal base station includes a user scheduling module 1301 and a transmission determining module 1302. Further, the normal base station also includes a performance estimating module 1303, a transmission switch 1304, a determination storing module 1305, and an actual throughput calculating module 1306. As a matter to be explained, the operation executed by each module of the normal base station in FIG. 13 can be known from the flow in FIG. 10 and its explanation is omitted here.

As a matter to be explained, in the embodiments illustrated in FIGS. 1 to 13, though the parameters for determining a transmission determination result in FIGS. 10 and 13 are actual throughputs, the parameters in the other embodiments may be estimated throughputs. And, in the above-described embodiments, the priority may indicate weighting throughputs at all transmission points in any appropriate case. For example, in the MeNB with transmission case, the priority may be a weighting sum of throughputs of an MeNB apparatus and a plurality of PeNB apparatuses. The priority in the MeNB without transmission may be a weighting sum of throughputs of one or a plurality of PeNB apparatuses.

In addition, the above-described embodiments have been presented specifically by way of example of a pico base station (PeNB) and a macro base station (MeNB), however this is not intended to limit the solving means of the present invention. For example, the PeNB may be replaced with any other low-power base station or the MeNB may be replaced with another normal base station. In addition, plural low-power base stations located within coverage of one normal base station may include various kinds of base stations such as PeNB and femto eNB.

As is clear from this, according to the present invention, a priority for the case of normal base station without transmission (mute case) and a priority for the case of normal base station with transmission (non-mute case) are determined based on performance estimating parameters for the respective cases of normal base station without transmission and normal base station with transmission of one or a plurality of low-power base stations thereby to obtain a transmission determination result. With this structure, it is possible to make better control of a transmission ratio of the normal base station, thereby improving inter-cell interference coordination performance.

Needless to say, the above-described embodiments of the present invention have been illustratively explained as being used in a heterogeneous network, however, the present invention is not limited to application to the heterogeneous network. The method may be used in a other-type radio network to perform inter-cell interference coordination.

The above description has been made only of the preferable embodiments of the present invention and is not intended to limit the protective scope of the present invention. It should be noted that various modifications, equivalent replacement and improvements made in the spirit and principle of the present invention fall within the scope of protection the present invention.

The disclosure of Chinese Patent Application No. 201110137290.0, filed on May 17, 2011, including the specification, drawings, and abstract, is incorporated herein by reference in its entirety.

1. A method for coordinating inter-cell interference in a radio network including a normal base station and one or a plurality of low-power base stations within coverage of the normal base station as transmission points, the method comprising:
a step A of the normal base station performing scheduling based on feedback information of a user of the normal base station and obtaining a user scheduling result of the normal base station including a parameter about an actual transmission characteristic of the normal base station;
a step B of the normal base station obtaining a performance estimating parameter including a parameter about an actual transmission characteristic of each of the one or plurality of low-power base stations for both cases of normal base station without transmission and normal base station with transmission;
a step C of the normal base station using the performance estimating parameter and the user scheduling result of the normal base station as a basis to determine weighting throughputs of all the transmission points for the case of normal base station without transmission and weighting throughputs of all the transmission points for the case of normal base station with transmission; and
a step D of the normal base station comparing the weighting throughputs of all the transmission points, obtaining a transmission determination result and performing data transmission based on the transmission determination result.

2. The method of claim 1, wherein the step B includes the normal base station receiving feedback information of a user of the one or plurality of low-power base stations, performing user scheduling of each of the low-power base stations for the case of normal base station without transmission to obtain a first user set A_{Pj}, performing user scheduling of each of the low-power base stations for the case of normal base station with transmission to obtain a second user set B_{Pj}, performing performance estimation on the first user set A_{Pj} and second user set B_{Pj}, and obtaining an appropriate performance estimating parameter.

3. The method of claim 2, further comprising:
the normal base station sending the transmission determination result as feedback to the one or plurality of low-power base stations, and
each of the low-power base stations performing user scheduling of own station based on the transmission determination result thereby to perform data transmission.

4. The method of claim 1, further comprising, prior to the step B,
each of the low-power base stations performing pre-scheduling based on feedback information of a user of own station and obtaining a first user set A_{Pj} for the case of normal base station without transmission and a second user set B_{Pj} for the case of normal base station with transmission; and
each of the low-power base stations performing performance estimation on each of the first user set A_{Pj} and the second user set B_{Pj} and feeding an obtained performance estimating parameter back to the normal base station.

5. The method of claim 4, further comprising:
the normal base station feeding the transmission determination result to the one or plurality of low-power base stations; and
each of the one or plurality of low-power base stations using the transmission determination result as a basis to determine an appropriate user set out of the first user set A_{Pj} and the second user set B_{Pj} and performing data transmission.

6. The method of claim 1, wherein in the step C, the normal base station determines the weighting throughputs of all the transmission points for the case of normal base station without transmission by using an equation:
$${\sum }_{j = 1}^{{N}_{PeNB}} {\sum }_{i ∈ {A}_{{p}_{j}}} \frac{{R}_{{p}_{j} , i}^{′} ( t )}{{\overline{R}}_{{p}_{j} , i} ( t ) \cdot {N}_{{p}_{j}}} or {\sum }_{j = 1}^{{N}_{PeNB}} {\sum }_{i ∈ {A}_{{p}_{j}}} \frac{{R}_{{p}_{j} , i}^{′} ( t )}{{\overline{R}}_{{p}_{j} , i} ( t ) \cdot f ( {N}_{{p}_{j}} )}$$
and determines the weighting throughputs of all the transmission points for the case of normal base station with transmission by using an equation:
$${\sum }_{i ∈ {M}_{m}} \frac{{R}_{m , i} ( t )}{{\overline{R}}_{m , i} ( t ) \cdot {N}_{m}} + {\sum }_{j = 1}^{{N}_{PeNB}} {\sum }_{i ∈ {B}_{{p}_{j}}} \frac{{R}_{{p}_{j} , i} ( t )}{{\overline{R}}_{{p}_{j} , i} ( t ) \cdot {N}_{{p}_{j}}} or$$
$${\sum }_{i ∈ {M}_{m}} \frac{{R}_{m , i} ( t )}{{\overline{R}}_{m , i} ( t ) \cdot f ( {N}_{m} )} + {\sum }_{j = 1}^{{N}_{PeNB}} {\sum }_{i ∈ {B}_{{p}_{j}}} \frac{{R}_{{p}_{j} , i} ( t )}{{\overline{R}}_{{p}_{j} , i} ( t ) \cdot f ( {N}_{{p}_{j}} )} ,$$
where t denotes a current time, i denotes a user number of the normal base station or each of the one or plurality of low-power base stations, j denotes a low-power base station number, Pⱼ denotes a j-th low-power base station, N_{PeNB} denotes a number of low-power base stations, Nₘ denotes a number of users of the normal base station, f(Nₘ) denotes a function of Nₘ, N_{Pj} denotes a number of users of the j-th low-power base station, f(N_{Pj}) is a function of N_{Pj}, Rₚ_{ⱼ}_{,i}′ denotes a throughput of an i-th user in an appropriate user set of the j-th low-power base station for the case of normal base station without transmission, Rₚ_{ⱼ}_{,i} denotes a throughput of the i-th user in an appropriate user set of the j-th low-power base station for the case of normal base station with transmission, R̅ₚ_{ⱼ}_{,i} denotes an average throughput of the i-th user in an appropriate user set of the j-th low-power base station, R_{m,i} denotes a throughput of an i-th user in an appropriate user set of the normal base station, R̅_{m,i} denotes an average throughput of the i-th user in an appropriate user set of the normal base station, A_{Pj} denotes a first user set scheduled by the j-th low-power base station for the case of normal base station without transmission, B_{Pj} denotes a second user set scheduled by the j-th low-power base station for the case of normal base station with transmission, Mₘ denotes a normal base station user set scheduled by the normal base station.

7. The method of claim 1, wherein, in the step C, the normal base station determines the weighting throughputs of all the transmission points for the case of normal base station without transmission by using an equation:
$${\sum }_{j = 1}^{{N}_{PeNB}} {\sum }_{i ∈ {A}_{{p}_{j}}} \frac{{R}_{{p}_{j} , i}^{′} ( t )}{{\overline{C}}_{{p}_{j}} ( t )} or {\sum }_{j = 1}^{{N}_{PeNB}} {\sum }_{i ∈ {A}_{{p}_{j}}} \frac{{R}_{{p}_{j} , i}^{′} ( t )}{f ( {\overline{C}}_{{p}_{j}} ( t ) )}$$
and determines the weighting throughputs of all the transmission points for the case of normal base station with transmission by using an equation:
$${\sum }_{i ∈ {M}_{m}} \frac{{R}_{m , i} ( t )}{{\overline{C}}_{m} ( t )} + {\sum }_{j = 1}^{{N}_{PeNB}} {\sum }_{i ∈ {B}_{{p}_{j}}} \frac{{R}_{{p}_{j} , i} ( t )}{{\overline{C}}_{{p}_{j}} ( t )} or$$
$${\sum }_{i ∈ {M}_{m}} \frac{{R}_{m , i} ( t )}{f ( {\overline{C}}_{m} ( t ) )} + {\sum }_{j = 1}^{{N}_{PeNB}} {\sum }_{i ∈ {B}_{{p}_{j}}} \frac{{R}_{{p}_{j} , i} ( t )}{f ( {\overline{C}}_{{p}_{j}} ( t ) )}$$
where t denotes a current time, i denotes a user number of the normal base station or each of the one or plurality of low-power base stations, j denotes a low-power base station number, Pⱼ denotes a j-th low-power base station, N_{PeNB} denotes a number of low-power base stations, Rₚ_{ⱼ}_{,i}′ denotes a throughput of an i-th user in an appropriate user set of the j-th low-power base station for the case of normal base station without transmission, Rₚ_{ⱼ}_{,i} denotes a throughput of the i-th user in an appropriate user set of the j-th low-power base station for the case of normal base station with transmission, R_{m,i} denotes a throughput of an i-th user in an appropriate user set of the normal base station, C̅ₚ_{ⱼ} denotes an average throughput of the j-th low-power base station, f( C̅ₚ_{ⱼ}(t)) is a function of C̅ₚ_{ⱼ}, C̅ₘ denotes an average throughput of the normal base station,
f( C̅ₘ(t)) is a function of C̅ₘ, A_{Pj} denotes a first user set scheduled by the j-th low-power base station for the case of normal base station without transmission, B_{Pj} denotes a second user set scheduled by the j-th low-power base station for the case of normal base station with transmission, Mₙ, denotes a normal base station user set scheduled by the normal base station.

8. The method of claim 1, further comprising the normal base station storing frame number information of own station.

9. The method of claim 8, wherein in the step C, the normal base station determines the weighting throughputs of all the transmission points for the case of normal base station without transmission by using an equation:
$$( {\sum }_{j = 1}^{{N}_{PeNB}} {\sum }_{i ∈ {A}_{{P}_{j}}} {R}_{{p}_{j} , i}^{′} ( t ) ) \cdot ( T - {T}_{m} ) or \\ ( {\sum }_{j = 1}^{{N}_{PeNB}} {\sum }_{i ∈ {A}_{{P}_{j}}} {R}_{{p}_{j} , i}^{′} ( t ) ) \cdot {f}_{1} ( T , {T}_{m} , {T}_{n} )$$
and determines the weighting throughputs of all the transmission points for the case of normal base station with transmission by using an equation:
$$( {\sum }_{i ∈ {M}_{m}} {R}_{m , i} ( t ) + {\sum }_{j = 1}^{{N}_{PeNB}} {\sum }_{i ∈ {B}_{{P}_{j}}} {R}_{{p}_{j} , i} ( t ) ) \cdot ( T - {T}_{n} )$$
$$or \\ ( {\sum }_{i ∈ {M}_{m}} {R}_{m , i} ( t ) + {\sum }_{j = 1}^{{N}_{PeNB}} {\sum }_{i ∈ {B}_{{P}_{j}}} {R}_{{p}_{j} , i} ( t ) ) \cdot {f}_{2} ( T , {T}_{m} , {T}_{n} )$$
where t denotes a current time, i denotes a user number of the normal base station or each of the one or plurality of low-power base stations, j denotes a low-power base station number, Pⱼ denotes a j-th low-power base station, N_{PeNB} denotes a number of low-power base stations, Rₚ_{ⱼ}_{,i}′ denotes a throughput of an i-th user in an appropriate user set of the j-th low-power base station for the case of normal base station without transmission, Rₚ_{ⱼ}_{,i} denotes a throughput of the i-th user in an appropriate user set of the j-th low-power base station for the case of normal base station with transmission, R_{m,i} denotes a throughput of an i-th user in an appropriate user set of the normal base station, A_{Pj} denotes a first user set scheduled by the j-th low-power base station for the case of normal base station without transmission, B_{Pj} denotes a second user set scheduled by the j-th low-power base station for the case of normal base station with transmission, T denotes a total number of frames, Tₘ denotes a number of frames without transmission of the normal base station, Tₙ denotes a number of frames with transmission of the normal base station, f₁(T, Tₘ, Tₙ) and f₂(T, Tₘ, Tₙ) both denote functions of T, Tₘ, Tₙ.

10. The method of claim 8, wherein in the step C, the normal base station determines the weighting throughputs of all the transmission points for the case of normal base station without transmission by using an equation:
$$( {\sum }_{j = 1}^{{N}_{PeNB}} {\sum }_{i ∈ {A}_{{P}_{j}}} \frac{{R}_{{p}_{j} , i}^{′} ( t )}{{\overline{R}}_{{p}_{j} , t} ( t )} ) \cdot ( T - {T}_{m} ) or \\ ( {\sum }_{j = 1}^{{N}_{PeNB}} {\sum }_{i ∈ {A}_{{P}_{j}}} \frac{{R}_{{p}_{j} , i}^{′} ( t )}{{\overline{R}}_{{p}_{j} , t} ( t )} ) \cdot {f}_{1} ( T , {T}_{m} , {T}_{n} )$$
and determines the weighting throughputs of all the transmission points for the case of normal base station with transmission by using an equation:
$$( {\sum }_{i ∈ {M}_{m}} \frac{{R}_{m , i} ( t )}{{\overline{R}}_{m , i} ( t )} + {\sum }_{j = 1}^{{N}_{PeNB}} {\sum }_{i ∈ {B}_{{P}_{j}}} \frac{{R}_{{p}_{j} , t} ( t )}{{\overline{R}}_{{p}_{j} , i} ( t )} ) \cdot ( T - {T}_{n} ) or \\ ( {\sum }_{i ∈ {M}_{m}} \frac{{R}_{m , i} ( t )}{{\overline{R}}_{m , i} ( t )} + {\sum }_{j = 1}^{{N}_{PeNB}} {\sum }_{i ∈ {B}_{{P}_{j}}} \frac{{R}_{{p}_{j} , i} ( t )}{{\overline{R}}_{{p}_{j} , i} ( t )} ) \cdot {f}_{2} ( T , {T}_{m} , {T}_{n} )$$
where t denotes a current time, i denotes a user number of the normal base station or each of the one or plurality of low-power base stations, j denotes a low-power base station number, Pⱼ denotes a j-th low-power base station, N_{PeNB} denotes a number of low-power base stations, Rₚ_{ⱼ}_{,i}′ denotes a throughput of an i-th user in an appropriate user set of the j-th low-power base station for the case of normal base station without transmission, Rₚ_{ⱼ}_{,i} denotes a throughput of the i-th user in an appropriate user set of the j-th low-power base station for the case of normal base station with transmission, R̅ₚ_{ⱼ}_{,i} denotes an average throughput of the i-th user in an appropriate user set of the j-th low-power base station, R_{m,i} denotes a throughput of an i-th user in an appropriate user set of the normal base station, R̅_{m,i} denotes an average throughput of the i-th user in an appropriate user set of the normal base station, A_{Pj} denotes a first user set scheduled by the j-th low-power base station for the case of normal base station without transmission, B_{Pj} denotes a second user set scheduled by the j-th low-power base station for the case of normal base station with transmission, T denotes a total number of frames, Tₘ denotes a number of frames without transmission of the normal base station, Tₙ denotes a number of frames with transmission of the normal base station, f₁(T, Tₘ, Tₙ) and f₂(T, Tₘ, Tₙ) both denote functions of T, Tₘ, Tₙ.

11. The method of claim 1, wherein in the step C, the normal base station determines the weighting throughputs of all the transmission points for the case of normal base station without transmission by using an equation:
$${\sum }_{j = 1}^{{N}_{PeNB}} {\sum }_{i ∈ {A}_{{P}_{j}}} \frac{{R}_{{p}_{j} , i}^{′} ( t )}{{W}_{{p}_{j} , i} ( t )} or$$
$${\sum }_{j = 1}^{{N}_{PeNB}} {\sum }_{i ∈ {A}_{{P}_{j}}} \frac{{R}_{{p}_{j} , i}^{′} ( t )}{f ( {W}_{{p}_{j} , i} ( t ) )}$$
and determines the weighting throughputs of all the transmission points for the case of normal base station with transmission by using an equation:
$${\sum }_{i ∈ {M}_{m}} \frac{{R}_{m , i} ( t )}{{W}_{m , i} ( t )} + {\sum }_{j = 1}^{{N}_{PeNB}} {\sum }_{i ∈ {B}_{{P}_{j}}} \frac{{R}_{{p}_{j} , i} ( t )}{{W}_{{p}_{j} , i} ( t )} or$$
$${\sum }_{i ∈ {M}_{m}} \frac{{R}_{m , i} ( t )}{f ( {W}_{m , i} ( t ) )} + {\sum }_{j = 1}^{{N}_{PeNB}} {\sum }_{i ∈ {B}_{{P}_{j}}} \frac{{R}_{{p}_{j} , i} ( t )}{f ( {W}_{{p}_{j} , i} ( t ) )}$$
where W_{Pj,i} (t) denotes a total amount of data to transmit to an i-th user in an appropriate user set of a j-th low-power base station, f(W_{Pj,i}(t)) denotes a function of W_{Pj,i}(t), W_{m,i}(t) denotes a total amount of data to transmit to an i-th user in an appropriate user set of the normal base station, and f(W_{m,i}(t)) denotes a function of W_{m,i}(t).

12. The method of claim 1, wherein in the step C, the normal base station determines the weighting throughputs of all the transmission points for the case of normal base station without transmission by using an equation:
$${\sum }_{j = 1}^{{N}_{PeNB}} {\sum }_{i ∈ {A}_{{P}_{j}}} ( {R}_{{p}_{j} , i}^{′} ( t ) \cdot {S}_{{p}_{j} , i} ( t ) ) or$$
$${\sum }_{j = 1}^{{N}_{PeNB}} {\sum }_{i ∈ {A}_{{P}_{j}}} ( {R}_{{p}_{j} , i}^{′} ( t ) \cdot f ( {S}_{{p}_{j} , i} ( t ) ) )$$
and determines the weighting throughputs of all the transmission points for the case of normal base station with transmission by using an equation:
$${\sum }_{i ∈ {M}_{m}} ( {R}_{m , i} ( t ) \cdot {S}_{m , i} ( t ) ) + {\sum }_{j = 1}^{{N}_{PeNB}} {\sum }_{i ∈ {B}_{{P}_{j}}} ( {R}_{{p}_{j} , i} ( t ) \cdot {S}_{{p}_{j} , i} ( t ) ) or$$
$${\sum }_{i ∈ {M}_{m}} ( {R}_{m , i} ( t ) \cdot f ( {S}_{m , i} ( t ) ) ) + {\sum }_{j = 1}^{{N}_{PeNB}} {\sum }_{i ∈ {B}_{{P}_{j}}} ( {R}_{{p}_{j} , i} ( t ) \cdot f ( {S}_{{p}_{j} , i} ( t ) ) )$$
where S_{Pj,i}(t) denotes a total amount of data to transmit to an i-th user in an appropriate user set of a j-th low-power base station, f(S_{Pj,i}(t)) denotes a function of S_{Pj,i}(t), S_{m,i}(t) denotes a total amount of data to transmit to an i-th user in an appropriate user set of the normal base station, and f(S_{m,i}(t)) denotes a function of S_{m,i}(t).

13. A base station in a radio network comprising:
a user scheduling module configured to perform scheduling based on feedback information of a user of a normal base station and obtain a user scheduling result of the normal base station including a parameter about an actual transmission characteristic of the normal base station; and
a transmission determining module configured to obtain a performance estimating parameter including a parameter about an actual transmission characteristic of each of one or a plurality of low-power base stations for both cases of normal base station without transmission and normal base station with transmission, use the performance estimating parameter and the user scheduling result of the normal base station as a basis to determine weighting throughputs of all the transmission points for the case of normal base station without transmission and weighting throughputs of all the transmission points for the case of normal base station with transmission, and compare the weighting throughputs of all the transmission points to obtain a transmission determination result.

14. The base station of claim 13, further comprising a performance estimating module configured to receive feedback information of a user of the one or plurality of low-power base stations, perform user scheduling of each of the low-power base stations for the case of normal base station without transmission to obtain a first user set A_{Pj}, perform user scheduling of each of the low-power base stations for the case of normal base stations with transmission to obtain a second user set B_{Pj}, perform performance estimation on the first user set A_{Pj} and second user set B_{Pj}, and obtain an appropriate performance estimating parameter.

15. The base station of claim 13, further comprising a transmission switch configured to switch on or off data transmission of the normal base station based on the transmission determination result.

16. The base station of claim 13, wherein the transmission determining module is configured to determine the weighting throughputs of all the transmission points for the case of normal base station without transmission by using an equation:
$${\sum }_{j = 1}^{{N}_{PeNB}} {\sum }_{i ∈ {A}_{{p}_{j}}} \frac{{R}_{{p}_{j} , i}^{′} ( t )}{{\overline{R}}_{{p}_{j} , i} ( t ) \cdot {N}_{{p}_{j}}} or {\sum }_{j = 1}^{{N}_{PeNB}} {\sum }_{i ∈ {A}_{{p}_{j}}} \frac{{R}_{{p}_{j} , i}^{′} ( t )}{{\overline{R}}_{{p}_{j} , i} ( t ) \cdot f ( {N}_{{p}_{j}} )}$$
and determine the weighting throughputs of all the transmission points for the case of normal base station with transmission by using an equation:
$${\sum }_{i ∈ {M}_{m}} \frac{{R}_{m , i} ( t )}{{\overline{R}}_{m , i} ( t ) \cdot {N}_{m}} + {\sum }_{j = 1}^{{N}_{PeNB}} {\sum }_{i ∈ {B}_{{p}_{j}}} \frac{{R}_{{p}_{j} , i} ( t )}{{\overline{R}}_{{p}_{j} , i} ( t ) \cdot {N}_{{p}_{j}}} or$$
$${\sum }_{i ∈ {M}_{m}} \frac{{R}_{m , i} ( t )}{{\overline{R}}_{m , i} ( t ) \cdot f ( {N}_{m} )} + {\sum }_{j = 1}^{{N}_{PeNB}} {\sum }_{i ∈ {B}_{{p}_{j}}} \frac{{R}_{{p}_{j} , i} ( t )}{{\overline{R}}_{{p}_{j} , i} ( t ) \cdot f ( {N}_{{p}_{j}} )}$$
where t denotes a current time, i denotes a user number of the normal base station or each of the one or plurality of low-power base stations, j denotes a low-power base station number, Pⱼ denotes a j-th low-power base station, N_{PeNB} denotes a number of low-power base stations, Nₘ denotes a number of users of the normal base station, f(Nₘ) denotes a function of Nₘ, N_{Pj} denotes a number of users of the j-th low-power base station, f(N_{Pj}) is a function of N_{Pj}, Rₚ_{ⱼ}_{,i}′ denotes a throughput of an i-th user in an appropriate user set of the j-th low-power base station for the case of normal base station without transmission, Rₚ_{ⱼ}_{,i}(t) denotes a throughput of the i-th user in an appropriate user set of the j-th low-power base station for the case of normal base station with transmission, R̅ₚ_{ⱼ}_{,i} denotes an average throughput of the i-th user in an appropriate user set of the j-th low-power base station, R_{m,i} denotes a throughput of an i-th user in an appropriate user set of the normal base station, R̅_{m,i} denotes an average throughput of the i-th user in an appropriate user set of the normal base station, A_{Pj} denotes a first user set scheduled by the j-th low-power base station for the case of normal base station without transmission, B_{Pj} denotes a second user set scheduled by the j-th low-power base station for the case of normal base station with transmission, Mₘ denotes a normal base station user set scheduled by the normal base station.

17. The base station of claim 13, wherein the transmission determining module is configured to determine the weighting throughputs of all the transmission points for the case of normal base station without transmission by using an equation:
$${\sum }_{j = 1}^{{N}_{PeNB}} {\sum }_{i ∈ {A}_{{p}_{j}}} \frac{{R}_{{p}_{j} , i}^{′} ( t )}{{\overline{C}}_{{p}_{j}} ( t )} or {\sum }_{j = 1}^{{N}_{PeNB}} {\sum }_{i ∈ {A}_{{p}_{j}}} \frac{{R}_{{p}_{j} , i}^{′} ( t )}{f ( {\overline{C}}_{{p}_{j}} ( t ) )}$$
and determine the weighting throughputs of all the transmission points for the case of normal base station with transmission by using an equation:
$${\sum }_{j = 1} \frac{{R}_{m , i} ( t )}{{\overline{C}}_{m} ( t )} + {\sum }_{j = 1}^{{N}_{PeNB}} {\sum }_{i ∈ {B}_{{p}_{j}}} \frac{{R}_{{p}_{j} , t} ( t )}{{\overline{C}}_{{p}_{j}} ( t )} or$$
$${\sum }_{i ∈ {M}_{m}} \frac{{R}_{m , i} ( t )}{f ( {\overline{C}}_{m} ( t ) )} + {\sum }_{j = 1}^{{N}_{PeNB}} {\sum }_{i ∈ {B}_{{p}_{j}}} \frac{{R}_{{p}_{j} , i} ( t )}{f ( {\overline{C}}_{{p}_{j}} ( t ) )}$$
where t denotes a current time, i denotes a user number of the normal base station or each of the one or plurality of low-power base stations, j denotes a low-power base station number, Pⱼ denotes a j-th low-power base station, N_{PeNB} denotes a number of low-power base stations, Rₚ_{ⱼ}_{,i}′ denotes a throughput of an i-th user in an appropriate user set of the j-th low-power base station for the case of normal base station without transmission, Rₚ_{ⱼ}_{,i} denotes an average throughput of the i-th user in an appropriate user set of the j-th low-power base station, R_{m,i} denotes a throughput of an i-th user in an appropriate user set of the normal base station, C̅_{P}_{ⱼ} denotes an average throughput of the j-th low-power base station, f( C̅ₚ_{ⱼ}(t)) is a function of C̅ₚ_{ⱼ}, C̅ₘ denotes an average throughput of the normal base station, f( C̅ₘ(t)) is a function of C̅ₘ, A_{Pj} denotes a first user set scheduled by the j-th low-power base station for the case of normal base station without transmission, B_{Pj} denotes a second user set scheduled by the j-th low-power base station for the case of normal base station with transmission, Mₘ denotes a normal base station user set scheduled by the normal base station.

18. The base station of claim 13, wherein the base station further comprises a transmission storing module configured to store frame number information of the normal base station, and the transmission determining module is configured to determine the weighting throughputs of all the transmission points for the case of normal base station without transmission by using an equation:
$$( {\sum }_{j = 1}^{{N}_{PeNB}} {\sum }_{i ∈ {A}_{{P}_{j}}} {R}_{{p}_{j} , i}^{′} ( t ) ) \cdot ( T - {T}_{m} ) or \\ ( {\sum }_{j = 1}^{{N}_{PeNB}} {\sum }_{i ∈ {A}_{{P}_{j}}} {R}_{{p}_{j} , i}^{′} ( t ) ) \cdot {f}_{1} ( T , {T}_{m} , {T}_{n} )$$
and determine the weighting throughputs of all the transmission points for the case of normal base station with transmission by using an equation:
$$( {\sum }_{i ∈ {M}_{m}} {R}_{m , i} ( t ) + {\sum }_{j = 1}^{{N}_{PeNB}} {\sum }_{i ∈ {B}_{{P}_{j}}} {R}_{{p}_{j} , i} ( t ) ) \cdot ( T - {T}_{n} )$$
$$or \\ ( {\sum }_{i ∈ {M}_{m}} {R}_{m , i} ( t ) + {\sum }_{j = 1}^{{N}_{PeNB}} {\sum }_{i ∈ {B}_{{P}_{j}}} {R}_{{p}_{j} , i} ( t ) ) \cdot {f}_{2} ( T , {T}_{m} , {T}_{n} )$$
where t denotes a current time, i denotes a user number of the normal base station or each of the one or plurality of low-power base stations, j denotes a low-power base station number, Pⱼ denotes a j-th low-power base station, N_{PeNB} denotes a number of low-power base stations, Rₚ_{ⱼ}_{,i}′ denotes a throughput of an i-th user in an appropriate user set of the j-th low-power base station for the case of normal base station without transmission, Rₚ_{ⱼ}_{,i}(t) denotes a throughput of the i-th user in an appropriate user set of the j-th low-power base station for the case of normal base station with transmission, R_{m,i} denotes a throughput of an i-th user in an appropriate user set of the normal base station, A_{Pj} denotes a first user set scheduled by the j-th low-power base station for the case of normal base station without transmission, B_{Pj} denotes a second user set scheduled by the j-th low-power base station for the case of normal base station with transmission, T denotes a total number of frames, Tₘ denotes a number of frames without transmission of the normal base station, Tₙ denotes a number of frames with transmission of the normal base station, f₁(T, Tₘ, Tᵣ) and f₂(T, Tₘ, Tᵣ) both denote functions of T, Tₘ, Tₙ.

19. The base station of claim 13, wherein the base station further comprises a transmission storing module configured to store frame number information of the normal base station, and the transmission determining module is configured to determine the weighting throughputs of all the transmission points for the case of normal base station without transmission by using an equation:
$$( {\sum }_{j = 1}^{{N}_{PeNB}} {\sum }_{i ∈ {A}_{{P}_{j}}} \frac{{R}_{{p}_{j} , t} ( t )}{{\overline{R}}_{{p}_{j} , i} ( t )} ) \cdot ( T - {T}_{n} ) or \\ ( {\sum }_{j = 1}^{{N}_{PeNB}} {\sum }_{i ∈ {A}_{{P}_{j}}} \frac{{R}_{{p}_{j} , i} ( t )}{{\overline{R}}_{{p}_{j} , i} ( t )} ) \cdot {f}_{1} ( T , {T}_{m} , {T}_{n} )$$
and determine the weighting throughputs of all the transmission points for the case of normal base station with transmission by using an equation:
$$( {\sum }_{i ∈ {M}_{m}} \frac{{R}_{m , i} ( t )}{{\overline{R}}_{m , i} ( t )} + {\sum }_{j = 1}^{{N}_{PeNB}} {\sum }_{i ∈ {B}_{{P}_{j}}} \frac{{R}_{{p}_{j} , i} ( t )}{{\overline{R}}_{{p}_{j} , i} ( t )} ) \cdot ( T - {T}_{n} ) or \\ ( {\sum }_{i ∈ {M}_{m}} \frac{{R}_{m , i} ( t )}{{\overline{R}}_{m , i} ( t )} + {\sum }_{j = 1}^{{N}_{PeNB}} {\sum }_{i ∈ {B}_{{P}_{j}}} \frac{{R}_{{p}_{j} , i} ( t )}{{\overline{R}}_{{p}_{j} , i} ( t )} ) \cdot {f}_{2} ( T , {T}_{m} , {T}_{n} )$$
where t denotes a current time, i denotes a user number of the normal base station or each of the one or plurality of low-power base stations, j denotes a low-power base station number, Pⱼ denotes a j-th low-power base station, N_{PeNB} denotes a number of low-power base stations, Rₚ_{ⱼ}_{,i}′ denotes a throughput of an i-th user in an appropriate user set of the j-th low-power base station for the case of normal base station without transmission, Rₚ_{ⱼ}_{,i}(t) denotes a throughput of the i-th user in an appropriate user set of the j-th low-power base station for the case of normal base station with transmission, R̅ₚ_{ⱼ}_{,i} denotes an average throughput of the i-th user in an appropriate user set of the j-th low-power base station, R_{m,i} denotes a throughput of an i-th user in an appropriate user set of the normal base station, R̅_{m,i} denotes an average throughput of the i-th user in an appropriate user set of the normal base station, A_{Pj} denotes a first user set scheduled by the j-th low-power base station for the case of normal base station without transmission, B_{Pj} denotes a second user set scheduled by the j-th low-power base station for the case of normal base station with transmission, T denotes a total number of frames, Tₘ denotes a number of frames without transmission of the normal base station, Tₙ denotes a number of frames with transmission of the normal base station, f₁(T, Tₘ, Tₙ) and f₂(T, Tₘ, Tₙ) both denote functions of T, Tₘ, Tₙ.

20. The base station of claim 13, wherein the transmission determining module is configured to determine the weighting throughputs of all the transmission points for the case of normal base station without transmission by using an equation:
$${\sum }_{j = 1}^{{N}_{PeNB}} {\sum }_{i ∈ {A}_{{P}_{j}}} \frac{{R}_{{p}_{j} , i}^{′} ( t )}{{W}_{{p}_{j} , i} ( t )} or {\sum }_{j = 1}^{{N}_{PeNB}} {\sum }_{i ∈ {A}_{{P}_{j}}} \frac{{R}_{{p}_{j} , i}^{′} ( t )}{f ( {W}_{{p}_{j} , i} ( t ) )}$$
and determine the weighting throughputs of all the transmission points for the case of normal base station with transmission by using an equation:
$${\sum }_{i ∈ {M}_{m}} \frac{{R}_{m , i} ( t )}{{W}_{m , i} ( t )} + {\sum }_{j = 1}^{{N}_{PeNB}} {\sum }_{i ∈ {B}_{{P}_{j}}} \frac{{R}_{{p}_{j} , i} ( t )}{{W}_{{p}_{j} , i} ( t )} or$$
$${\sum }_{i ∈ {M}_{m}} \frac{{R}_{m , i} ( t )}{f ( {W}_{m , i} ( t ) )} + {\sum }_{j = 1}^{{N}_{PeNB}} {\sum }_{i ∈ {B}_{{P}_{j}}} \frac{{R}_{{p}_{j} , i} ( t )}{f ( {W}_{{p}_{j} , i} ( t ) )}$$
where W_{Pj,i}(t) denotes a total amount of data to transmit to an i-th user in an appropriate user set of a j-th low-power base station, f(W_{Pj,i}(t)) denotes a function of W_{Pj,i}(t), W_{m,i}(t) denotes a total amount of data to transmit to an i-th user in an appropriate user set of the normal base station, and f(W_{m,i}(t)) denotes a function of W_{m,i}(t).

21. The base station of claim 13, wherein the transmission determining module is configured to determines the weighting throughputs of all the transmission points for the case of normal base station without transmission by using an equation:
$${\sum }_{j = 1}^{{N}_{PeNB}} {\sum }_{i ∈ {A}_{{P}_{j}}} ( {R}_{{p}_{j} , i}^{′} ( t ) \cdot {S}_{{p}_{j} , i} ( t ) ) or {\sum }_{j = 1}^{{N}_{PeNB}} {\sum }_{i ∈ {A}_{{P}_{j}}} ( {R}_{{p}_{j} , i}^{′} ( t ) \cdot f ( {S}_{{p}_{j} , i} ( t ) ) )$$
and determine the weighting throughputs of all the transmission points for the case of normal base station with transmission by using an equation:
$${\sum }_{i ∈ {M}_{m}} ( {R}_{m , i} ( t ) \cdot {S}_{m , i} ( t ) ) + {\sum }_{j = 1}^{{N}_{PeNB}} {\sum }_{i ∈ {B}_{{P}_{j}}} ( {R}_{{p}_{j} , i} ( t ) \cdot {S}_{{p}_{j} , i} ( t ) ) or$$
$${\sum }_{i ∈ {M}_{m}} ( {R}_{m , i} ( t ) \cdot f ( {S}_{m , i} ( t ) ) ) + {\sum }_{j = 1}^{{N}_{PeNB}} {\sum }_{i ∈ {B}_{{P}_{j}}} ( {R}_{{p}_{j} , i} ( t ) \cdot f ( {S}_{{p}_{j} , i} ( t ) ) )$$
where S_{Pj,i}(t) denotes a total amount of data to transmit to an i-th user in an appropriate user set of a j-th low-power base station, f(S_{Pj,i}(t)) denotes a function of S_{Pj,i}(t), S_{m,i}(t) denotes a total amount of data to transmit to an i-th user in an appropriate user set of the normal base station, and f(S_{m,i}(t)) denotes a function of S_{m,i}(t).

22. A radio network comprising:
a normal base station configured to perform scheduling based on feedback information of a user of the normal base station to obtain a user scheduling result of the normal base station including a parameter about an actual transmission characteristic of the normal base station, obtain a performance estimating parameter including a parameter about an actual transmission characteristic of each of one or a plurality of low-power base stations within coverage of the normal base station for both cases of normal base station without transmission and normal base station with transmission, use the performance estimating parameter and the user scheduling result of the normal base station as a basis to determine weighting throughputs of all the transmission points for the case of normal base station without transmission and weighting throughputs of all the transmission points for the case of normal base station with transmission, compare the weighting throughputs of all the transmission points to obtain a transmission determination result and perform data transmission based on the transmission determination result; and
the one or a plurality of low-power base stations each configured to perform pre-scheduling based on feedback information of users of own station to obtain a first user set A_{Pj} for the case of normal base station without transmission and a second user set B_{Pj} for the case of normal base station with transmission, perform performance estimation on each of the first user set A_{Pj} and the second user set B_{Pj} and feed obtained performance estimating parameters back to the normal base station.

23. The radio network of claim 22, wherein
the normal base station is configured to feed the transmission determination result to the one or plurality of low-power base stations; and
each of the one or plurality of low-power base stations is configured to uses the transmission determination result as a basis to determine an appropriate user set out of the first user set A_{Pj} and the second user set B_{Pj} and performs data transmission.

24. A method for coordinating inter-cell interference in a radio network including a normal base station and one or a plurality of low-power base stations within coverage of the normal base station as transmission points, the method comprising:
a step A of the normal base station determining a throughput of the normal base station at a first time t1 based on a transmission determination result at a current time;
a step B of the normal base station obtaining a throughput of each of the one or plurality of low-power base stations at the first time t1; and
a step C of the normal base station comparing throughputs of all transmission points at the first time t1 and throughputs of all the transmission points at a second time t2 prior to the first time t, determining a transmission determination result at a next time t+1 based on a comparison result, and using the transmission determination result as a basis to allow an operation in accordance with a case of normal base station without transmission or a case of normal base station with transmission to be executed at the next time t+1.

25. The method of claim 24, wherein in the step A, when the transmission determination result at the current time t is a result of normal base station without transmission, the normal base station sets an estimated throughput Cₘ(t) at the current time t to 0, and when the transmission determination result at the current time t is a result of normal base station with transmission, the normal base station performs user scheduling of the normal base station and obtains an estimated throughput Cₘ(t) at the current time t.

26. The method of claim 24, wherein in the step B, when the transmission determination result at the current time t is a result of normal base station without transmission, the normal base station performs user scheduling of each of the one or plurality of low-power base stations in accordance with the case of normal base station without transmission and obtains a sum of estimated throughputs of the one or plurality of low-power base stations at the current time t:
$${\sum }_{j = 1}^{{N}_{PeNB}} {C}_{{p}_{j}} ( t ) ,$$
and when the transmission determination result at the current time t is a result of normal base station with transmission, the normal base station performs user scheduling of each of the one or plurality of low-power base stations in accordance with the case of normal base station with transmission and obtains a sum of estimated throughputs of the one or plurality of low-power base stations at the current time t:
$${\sum }_{j = 1}^{{N}_{PeNB}} {C}_{{p}_{j}} ( t ) .$$

27. The method of claim 24, wherein in the step B,
when the transmission determination result at the current time t is a result of normal base station without transmission, each of the one or plurality of low-power base stations performs user scheduling of the low-power base station in accordance with the case of normal base station without transmission, obtains an estimated throughput C_{Pj}(t) of own station at the current time t and transmits the estimated throughput to the normal base station, and
when the transmission determination result at the current time t is a result of normal base station with transmission, each of the one or plurality of low-power base stations performs user scheduling of the low-power base station in accordance with the case of normal base station with transmission, obtains an estimated throughput C_{Pj}(t) of own station at the current time t and transmits the estimated throughput to the normal base station.

28. The method of claim 24, wherein in the step C, the normal base station compares a total estimated throughput at the current time t:
$${C}_{m} ( t ) + {\sum }_{j = 1}^{{N}_{PeNB}} {C}_{{p}_{j}} ( t )$$
with a total estimated throughput at a previous time t−1:
$${C}_{m} ( t - 1 ) + {\sum }_{j = 1}^{{N}_{PeNB}} {C}_{{p}_{j}} ( t - 1 ) ,$$
when
$${C}_{m} ( t ) + {\sum }_{j = 1}^{{N}_{PeNB}} {C}_{{p}_{j}} ( t )$$
is greater than
$${C}_{m} ( t - 1 ) + {\sum }_{j = 1}^{{N}_{PeNB}} {C}_{{p}_{j}} ( t - 1 ) ,$$
the normal base station sets a transmission determination result at the next time t+1 to be identical with the transmission determination result at the current time 1, when
$${C}_{m} ( t ) + {\sum }_{j = 1}^{{N}_{PeNB}} {C}_{{p}_{j}} ( t )$$
is not greater than
$${C}_{m} ( t - 1 ) + {\sum }_{j = 1}^{{N}_{PeNB}} {C}_{{p}_{j}} ( t - 1 ) ,$$
the normal base station sets the transmission determination result at the next time t+1 to be opposite to the transmission determination result at the current time 1.

29. The method of claim 24, wherein in the step C, the normal base station compares an actual throughput at a first time t−τ:
$${\sum }_{i} ( {D}_{m , i} ( t - τ ) \cdot A {N}_{m , i} ( t - τ ) ) + {\sum }_{j = 1}^{{N}_{PeNB}} {\sum }_{i} ( {D}_{{P}_{j} , i} ( t - τ ) \cdot A {N}_{{P}_{j} , i } ( t - τ ) )$$
with an actual throughput at a second time t−τ−1:
$${\sum }_{i} ( {D}_{m , i} ( t - τ - 1 ) \cdot A {N}_{m , i} ( t - τ - 1 ) ) + {\sum }_{j = 1}^{{N}_{PeNB}} {\sum }_{i} ( {D}_{{P}_{j} , i} ( t - τ - 1 ) \cdot A {N}_{{P}_{j} , i } ( t - τ - 1 ) ) ,$$
when the actual throughput at the first time t−τ is greater than the actual throughput at the second time t−τ−1, the normal base station sets a transmission determination result at the next time t+1 to be identical with the transmission determination result at the current time t, and
when the actual throughput at the first time t−τ is not greater than the actual throughput at the second time t−τ−1, the normal base station sets the transmission determination result at the next time t+1 to be opposite to the transmission determination result at the current time t,
where D_{m,i} denotes an actual amount of transmission data of an i-th user of the normal base station, D_{Pj,i} denotes an actual amount of transmission data of an i-th user of an j-th low-power base station, AN_{m,i} denotes proper reception indication information of corresponding data of the i-th user of the normal base station, AN_{Pj,i} denotes proper reception indication information of corresponding data of the i-th user of the j-th low-power base station, and τ denotes a feedback time delay of proper reception indication information.
